(19) United States
(12) Patent Application Publication
(10) Pub. No.: US 2024/0422882 A1
(43) Pub. Date: Dec. 19, 2024

(54) LIGHTING APPARATUS INCORPORATING CONTROL APPARATUS WITH LED MODULE IDENTIFICATION

(71) Applicant: ARKALUMEN INC., Ottawa (CA)

(72) Inventors: James Allen KINGMAN, Woodside, CA (US); Sean MacLean MURRAY, Kingston (CA); Fan ZHANG, Ottawa (CA); Reza FETANAT, Ottawa (CA); Ayman YAGHI, Ottawa (CA)

(73) Assignee: ARKALUMEN INC., Ottawa (CA)

(21) Appl. No.: 18/620,755

(22) Filed: Mar. 28, 2024

Related U.S. Application Data
(60) Provisional application No. 63/468,529, filed on May 24, 2023.
(60) Provisional application No. 63/549,418, filed on Feb. 2, 2024.

(51) Int. Cl. H05B 47/14; F21V 7/00; F21V 29/77; F21Y 115/10; H05B 45/10; H05B 45/20; H05B 45/325

(52) U.S. Cl. CPC H05B 47/14; F21V 7/0091; F21V 29/77; H05B 45/10; H05B 45/20; H05B 45/325; F21Y 2115/10

(57) ABSTRACT

The present disclosure provides a lighting apparatus generally comprising an LED module having LEDs and a control module to control the LED module. The LED module has pins positioned on an underside thereof to connect to corresponding pins on the upper surface of the LED. The LED module having a passive electrical component whose value can be detected by the control apparatus. In response to said detection, the control apparatus can perform a variety of functions, including configuring the LED module. The lighting apparatus is further comprised of a reflector, the reflector positioned within a central aperture of the control module and surrounding the LEDs. The reflector serves to focus light from the LEDs and can be secured to a diffuser releasably lockable to the lighting apparatus, the diffuser to diffuse the light from the LEDs.

### CROSS REFERENCE TO RELATED APPLICATIONS

The present application claims priority to U.S. Provisional Application No. 63/468,529,titled “LIGHTING APPARATUS INCORPORATING CONTROL APPARATUS FOR CONTROLLING MULTI-CHANNEL LED MODULES” filed on May 24, 2023,and U.S. Provisional Application No. 63/549,418, titled “LIGHTING APPARATUS INCORPORATING CONTROL APPARATUS FOR CONTROLLING MULTI-CHANNEL LED MODULES” filed on Feb. 2, 2024, the contents of which are incorporated herein by reference in their entirety.

### FIELD OF THE INVENTION

The invention relates generally to lighting controls and, more particularly, to a lighting apparatus incorporating a control apparatus with LED module identification.

### BACKGROUND OF THE INVENTION

Use of light emitting diode (LED) modules and controllers therefor have increased drastically due to technological advances in LED light output and efficiency in the last two decades. More recently, solutions have been developed to provide increased control of multiple LEDs with longer LED lifespan and a reduced cost for LED manufacture.

However, many problems exist in the market. In particular, dimming multi-channel LED modules poses challenges as it is often difficult to include and integrate the control module within the mechanical encasing of the LED light fixture. Even when such integrated solutions exist, it is difficult to determine the maximum currents to operate the LEDs at or calibrate a mix of LEDs together to achieve particular spectra outputs.

Additionally, there are inherent issues in the mechanical encasings that can lead to malfunctioning or broken electrical connections to LED modules and poor thermal transfer from LED modules. Finally, it is difficult to utilize various types of reflectors and diffusers within the mechanical encasings to improve the diffused LED light and beamforming.

As such, there is a need for solutions in the lighting space that will mitigate at least one of the above problems.

### SUMMARY

In a first broad aspect, the present disclosure provides a lighting apparatus comprising: a light emitting diode (LED) module comprising: one or more LEDs to emit light; and an identification element; and a control apparatus electrically coupled to the LED module, the control apparatus operable to determine an identification indication related to the identification element and to control the LED module at least in part in response to the identification indication.

In some embodiments, the identification element is a passive electrical component, which may be a resistor with a particular resistance value. To determine the identification indication, the control apparatus may be operable to determine a voltage drop across the resistor.

In some embodiments, to control the LED module, the control module is operable to determine an operating configuration for the LED module at least in part in response to the identification indication and to control the LED module at least in part in response to the operating configuration for the LED module. The operating configuration may comprise at least a maximum current to apply to the LED module; and, to control the LED module, the control module may be further operable to control the LED module to ensure the current applied to the LED module is less than or equal to the maximum current. In some embodiments, the LED module comprises a plurality of LED channels. The operating configuration may comprise at least a respective maximum current to apply to each of the LED channels; and, to control the LED module, the control module may be further operable to control each of the LED channels to ensure the current applied to each of the LED channels is less than or equal to the respective maximum current. The operating configuration may comprise at least calibration information related to a mix of the plurality of LED channels required to achieve a particular lighting effect; and, to control the LED module, the control module may be further operable to control the LED channels to achieve the particular lighting effect. The operating configuration may comprise at least a predetermined voltage to apply to the LED module; and, to control the LED module, the control module may be further operable to control the LED channels to set a voltage to apply to the LED module to the predetermined voltage. The operating configuration may comprise at least a network identifier for the lighting apparatus; and, to control the LED module, the control module may be further operable to control the LED module in response to communications on a network using the network identifier.

In some embodiments, to control the LED module, the control module may be further operable to determine if a programmed configuration of the control module is acceptable considering the operating configuration of the LED module; and, if the programmed configuration of the control module is not acceptable considering the operating configuration of the LED module, to control the LED module to at least one of provide a warning indication; and disable the LED module.

In a second broad aspect, the present disclosure provides a control apparatus operable to be coupled within a lighting apparatus comprising a light emitting diode (LED) module further comprising: one or more LEDs to emit light; and an identification element; the control apparatus comprising: a control module, configured to be electrically coupled to the LED module, the control module operable to determine an identification indication related to the identification element and to control the LED module at least in part in response to the identification indication.

In a third broad aspect, the present disclosure provides a light emitting diode (LED) module comprising: one or more LEDs to emit light; and an identification resistor, the identification resistor comprising a particular resistance that can be used to determine an identification indication related to the LED module when current is applied across the identification resistor.

### BRIEF DESCRIPTION OF THE DRAWINGS

A detailed description of embodiments of the invention is provided herein below, by way of example only, with reference to the accompanying drawings, in which:

FIGS. 1A to 1G are block diagrams of a lighting apparatus including control apparatus according to various embodiments of the present invention;

FIGS. 2A and 2B are block diagrams of the control apparatus of FIG. 1A according to an embodiment of the present invention;

FIGS. 2C and 2D are block diagrams of the control apparatus of FIG. 1A according to an embodiment of the present invention;

FIGS. 3A, 3B and 3C are sample circuit diagrams of the PWM voltage converter module, PWM control CH1 module, and the voltage converter CH4 module respectively of FIG. 2A;

FIG. 4A and 4B are top and bottom views of a sample implementation of the control apparatus of FIG. 1A and FIG. 4C is a bottom view of a sample implementation of the control apparatus of FIG. 1B;

FIG. 5A is a top view of a sample implementation of the control apparatus of FIGS. 4A and 4B after encasement and FIG. 5B is a top view of the sample implementation with the removable LED module included;

FIGS. 6 is a breakout diagram illustrating the elements of FIG. 5B broken out for clarity;

FIG. 7A is a top view of a sample implementation of the lighting module of FIG. 1A and FIG. 7B is a top view of a sample implementation of the lighting module of FIG. 1B in which an ID element is included;

FIGS. 8A and 8B are top views of alternative implementations of the control apparatus of FIGS. 1A and 1B respectively;

FIG. 9 is an enlarged top view of an alternative sample implementation of a portion of the lighting module of FIG. 1B in which an ID element is included;

FIGS. 10A and 10B are circuit diagrams of a sample implementation of the lighting module of FIG. 1B;

FIG. 11 is a perspective view of a lighting apparatus according to an embodiment of the present invention;

FIG. 12 is an exploded front view of the lighting apparatus of FIG. 11, according to an embodiment of the present invention;

FIG. 13A is a perspective view of the lighting apparatus of FIG. 11 connected to a socket, according to an embodiment of the present invention;

FIG. 13B is an exploded view of the lighting apparatus of FIG. 11 with a socket and lens, according to an embodiment of the present invention;

FIG. 14A is a perspective cross-sectional view of the lighting apparatus of FIG. 13A, according to an embodiment of the present invention;

FIG. 14B is an enlarged perspective view along the stippled lines denoted in FIG. 14A, according to an embodiment of the present invention;

FIG. 15A is a perspective view of the lighting apparatus of FIG. 11 connected to a Total Internal Reflection (TIR) lens, according to an embodiment of the present invention;

FIG. 15B is an exploded view of the lighting apparatus of FIG. 15A, according to an embodiment of the present invention;

FIG. 16 is an exploded perspective view of a diffuser, top encasement and reflector of the lighting apparatus of FIG. 11, according to an embodiment of the present invention;

FIG. 17A is a perspective view of diffuser positioned over the reflector in an unsecured position of the lighting apparatus of FIG. 11, according to an embodiment of the present invention;

FIG. 17B is a perspective view of diffuser positioned over the reflector in a secured position of the lighting apparatus of FIG. 11, according to an embodiment of the present invention;

FIG. 17C is a front view of a first step (aligning) of the reflector being connected to the diffuser, according to an embodiment of the present invention;

FIG. 17D is a perspective view of a second step (inserting) of the reflector being connected to the diffuser, according to an embodiment of the present invention;

FIG. 17E is a perspective view of a third step (twisting) of the reflector being connected to the diffuser, according to an embodiment of the present invention;

FIG. 17F is a perspective view of a fourth step (locking) of the reflector being connected to the diffuser, according to an embodiment of the present invention;

FIG. 18 is a perspective cross-sectional view of a lighting apparatus having an alternate, wider reflector, according to another embodiment of the present invention;

FIG. 19 is an enlarged cross-sectional perspective view of the reflector secured to the diffuser within the lighting apparatus of FIG. 11, according to an embodiment of the present invention;

FIG. 20 is a perspective cross-sectional view of the lighting apparatus of FIG. 13A, according to an embodiment of the present invention;

FIG. 21 is an enlarged cross-sectional front view showing an adjustable offset between the top and bottom encasements of the lighting apparatus of FIG. 11, according to an embodiment of the present invention;

FIG. 22 is a cross-sectional front view of the lighting apparatus of FIG. 11, according to an embodiment of the present invention;

FIG. 23 is a perspective underside view of the control board having a spring element, according to an embodiment of the present invention;

FIG. 24 is an underside view of the lighting apparatus of FIG. 11, according to an embodiment of the present invention;

FIG. 25 is a perspective view of the LED module of the lighting apparatus of FIG. 11, according to an embodiment of the present invention;

FIG. 26A is a flowchart diagram of steps performed by a controller of the lighting apparatus, according to an embodiment of the present invention;

FIG. 26B is a flowchart diagram of steps performed by a controller of the lighting apparatus, according to another embodiment of the present invention;

FIG. 26C is a flowchart diagram of steps performed by a controller of the lighting apparatus, according to another embodiment of the present invention;

FIG. 26D is a flowchart diagram of steps performed by a controller of the lighting apparatus, according to another embodiment of the present invention;

It is to be expressly understood that the description and drawings are only for the purpose of illustration of certain embodiments of the invention and are an aid for understanding. They are not intended to be a definition of the limits of the invention.

### DETAILED DESCRIPTION OF EMBODIMENTS

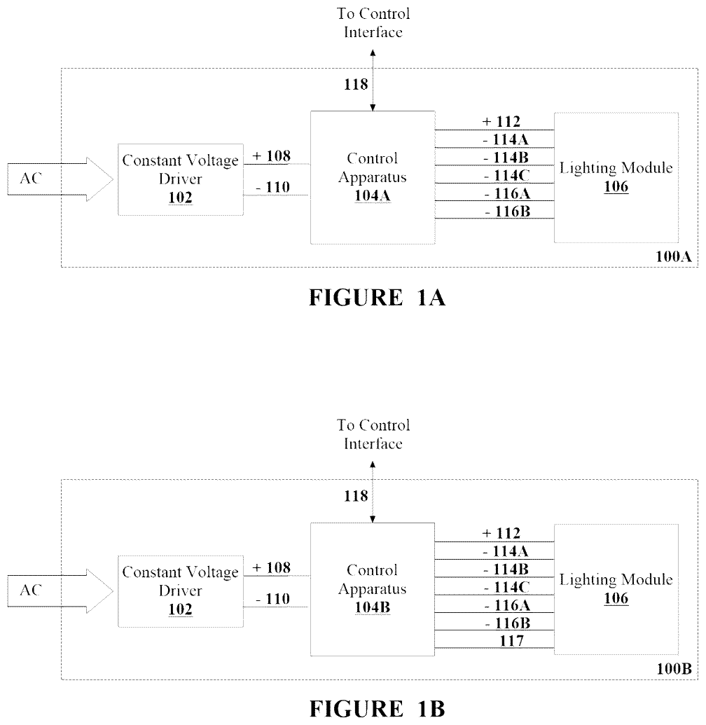

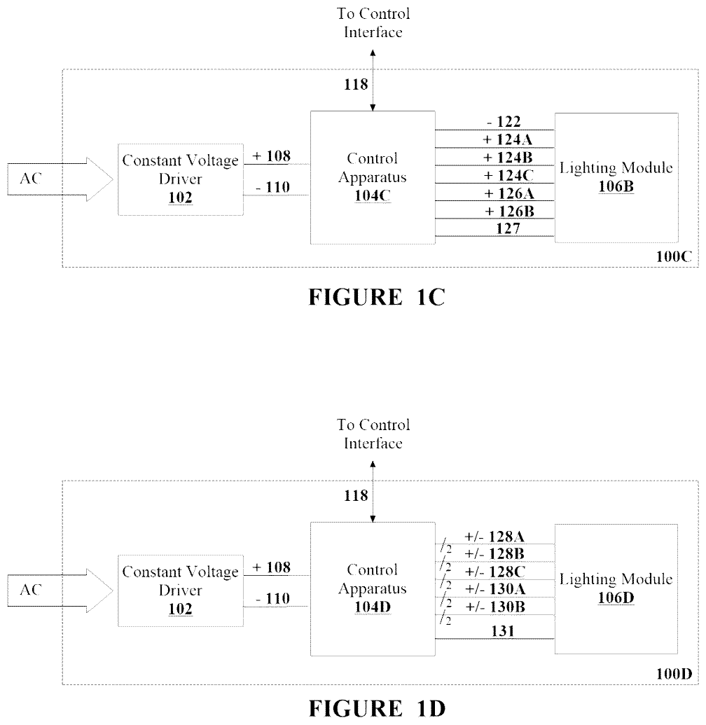

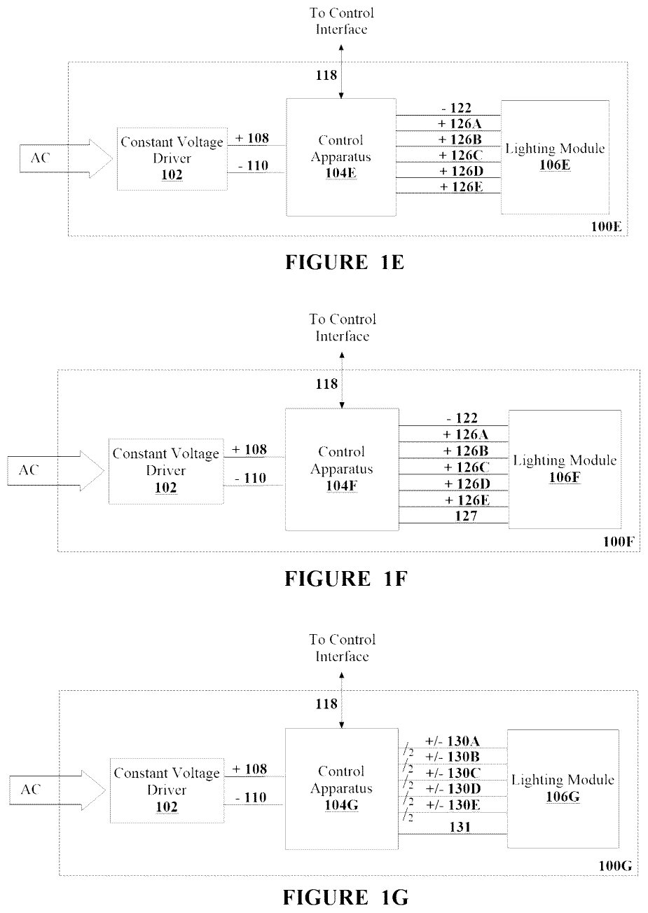

FIG. 1A is a block diagram of a lighting apparatus 100A according to an embodiment of the present invention comprising a constant voltage driver 102, a control apparatus 104A and a lighting module 106. The constant voltage driver 102 receives an AC input and outputs a constant DC voltage across positive/negative voltage rails 108, 110. The control apparatus 104A is connected to and powered by the positive/negative voltage rails 108, 110 and generates common positive output 112, Pulse Width Modulation (PWM) controlled outputs 114A, 114B, 114C and Constant Current Reduction (CCR) outputs 116A, 116B. Outputs 112, 114A, 114B, 114C, 116A, 116B are coupled to the lighting module 106. The control apparatus 104A is also coupled to a control interface via connection 118.

The constant voltage driver 102 may be implemented in a wide range of manners and electrical specifications depending on the application requirements of the lighting apparatus 100A. In one sample implementation, the constant voltage driver 102 is a well-known driver that operates with an AC input and a 24V DC output. In some embodiments, the constant voltage driver 102 may be removed from the lighting apparatus 100A and instead a constant voltage DC rail is the input to the lighting apparatus 100A directly into the control apparatus 104A.

There are many different potential implementations for a control apparatus in the lighting apparatus 100A such that it can output one or more PWM controlled channel outputs (114A, 114B, 114C in FIG. 1A) and one or more CCR controlled channel outputs (116A, 116B in FIG. 1A) from a single module. Outputting both PWM controlled channel outputs and CCR controlled channel outputs allows the matching lighting module 106 to have one or more LED channels controlled by PWM and one or more LED channels controlled by CCR within the same LED module. PWM controlled LED channels receive a particular instantaneous current from the control apparatus for an active period within a cycle and are inactive for the remainder of the cycle. The instantaneous current does not change but the percent of time that the LED channel is active is determined by the control apparatus, therefore controlling the perceived intensity of light output from the particular LED channel. CCR controlled LED channels receive a controlled current from the control apparatus and typically do not have a cycle of active/inactive periods.

The LED module 106 may comprise a plurality of LED channels with LEDs within the different LED channels comprising LEDs of different colors (ex. Red, blue, green, amber, cyan, etc) and/or LEDs of different color temperatures of white. One or more LED modules may also comprise a mix of LEDs of different color/color temperatures. LEDs of different color, manufacturing techniques, binning, brand, die size, packaging can dim differently with the same adjustments to current being applied. This provides an advantage of dimming a plurality of LED channels with different LEDs (ex. Red, blue, green LEDs in three different respective LED channels) using PWM where the instantaneous current stays the same. Therefore, if a calibration in which a particular percent output of each of a plurality of LED channels is desired to achieve an overall mixed color, PWM dimming of the LED channels can allow the calibration to be maintained during dimming. Calibrating LED channels that are dimmed by CCR can in some implementations be more complicated due to LEDs dimming at different rates. CCR dimming has the advantage of being flicker-free and allowing for no synchronization issues with photography or video capture.

The lighting apparatus 100B of FIG. 1B is similar to the lighting apparatus 100A of FIG. 1A but there is an additional LED module identification pin 117. In this implementation, the control apparatus 104B can detect an aspect of an identification element on the LED module 106. The identification element may take the form of a resistor in which can an aspect of the identification element may be a voltage drop across the resistor as measured between the identification pin 117 and a reference such as the common positive 112. In other embodiments, the identification element may comprise another passive component or an active component such as a microcontroller. By detecting the aspect of the identification element within the LED module 106, the control apparatus 104B can adjust a calibration profile that may apply to the LED module 106. The calibration profile may comprise a look-up table or a set of formulas for mixing intensities of the LED channels in the LED module 106, a look-up table or a set of formulas for dimming intensities of the LED channels, an indication of the forward voltage of one or more of the LED channels, and/or any other electrical parameters or performance metrics that would be required for the LED module. By way of example not intended to be limiting, an exemplary look-up table may be 256 rows with a current setting for each LED channel on each row. The number of rows would correspond to values in an 8-bit DMX address, and each row would represent a different correlated colour temperature (CCT) light output that can be selected. This auto identification of LED modules by the control apparatus 104B according to embodiments of the present invention are further illustrated in Figures.

The lighting apparatus 100C of FIG. 1C is similar to the lighting apparatus 100B of FIG. 1B but instead of using a common positive 112 and separate return paths 114A, 114B, 114C, 116A, 116B for each channel in the lighting module 106, the control apparatus 104C is coupled to the lighting module 106B with a common return path 122 and separate positives 124A, 124B, 124C, 126A, 126B for each channel and LED module identification pin 127.

The lighting apparatus 100D of FIG. 1D is similar to the lighting apparatus 100B of FIG. 1B but instead of using a common positive 112 and separate return paths 114A, 114B, 114C, 116A, 116B for each channel in the lighting module 106, the control apparatus 104D is coupled to the lighting module 106D with separate pairs of positive and return paths 128A, 128B, 128C, 130A, 130B for each channel and LED module identification pin 131.

With reference to FIG. 1E and according to an embodiment of the present invention, the lighting apparatus 100E is similar to the lighting apparatus 100A of FIG. 1A but instead of using PWM controlled channel outputs (114A, 114B, 114C in FIG. 1A) and CCR controlled channel outputs (116A, 116B in FIG. 1A), the control apparatus 104E uses five CCR controlled channel outputs 126A, 126B, 126C, 126D, 126E.

With reference to FIG. 1F and according to an embodiment of the present invention, the lighting apparatus 100F is similar to the lighting apparatus 100C of FIG. 1C but instead of using PWM controlled channel outputs (124A, 124B, 124C in FIG. 1C) and CCR controlled channel outputs (126A, 126B in FIG. 1C), the control apparatus 104E uses five CCR controlled channel outputs 126A, 126B, 126C, 126D, 126E.

With reference to FIG. 1G and according to an embodiment of the present invention, the lighting apparatus 100G is similar to the lighting apparatus 100D of FIG. 1D but instead of using PWM controlled channel outputs (128A, 128B, 128C in FIG. 1D) and CCR controlled channel outputs (130A, 130B in FIG. 1D), the control apparatus 104G uses five CCR controlled channel outputs 130A, 130B, 130C, 130D, 130E.

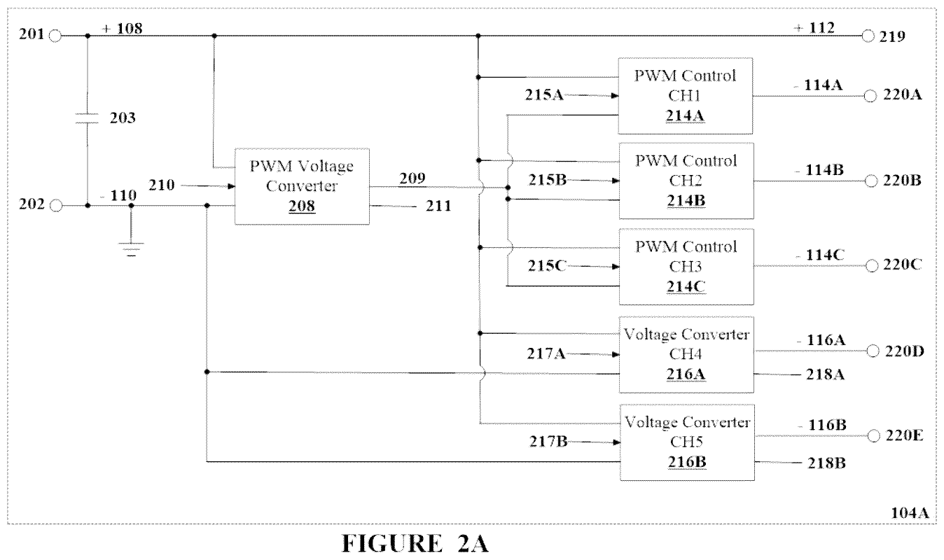

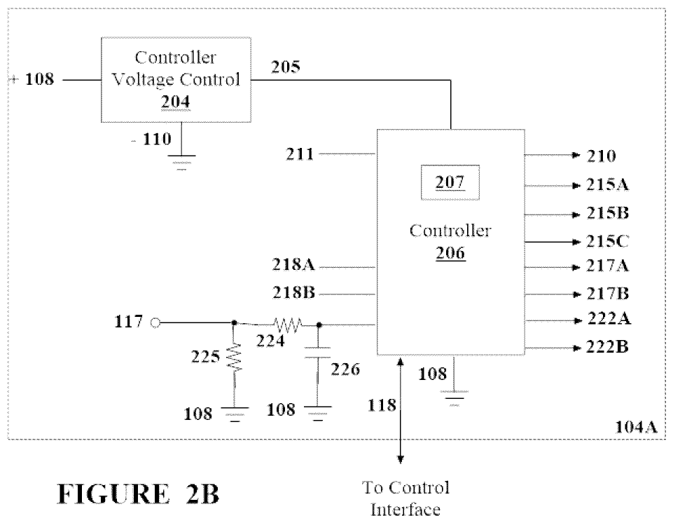

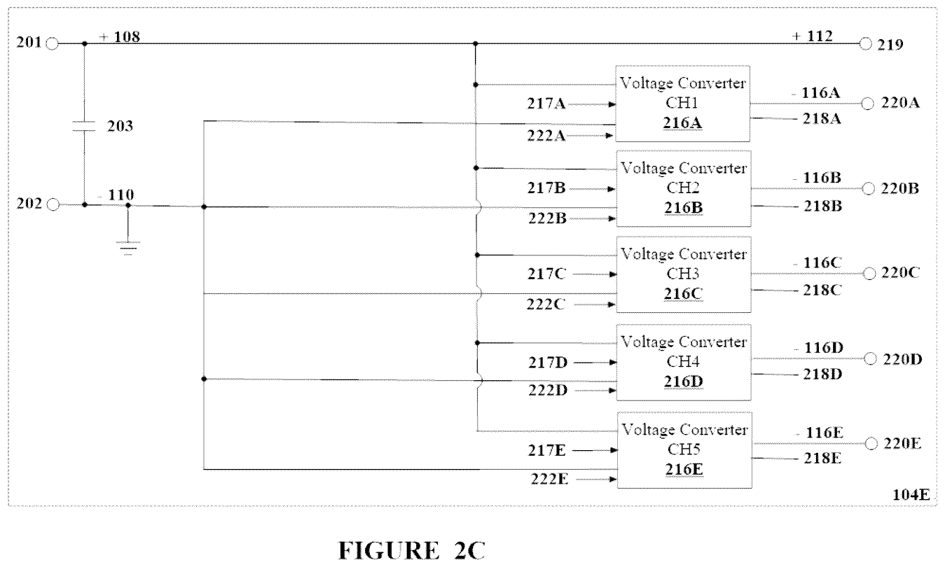

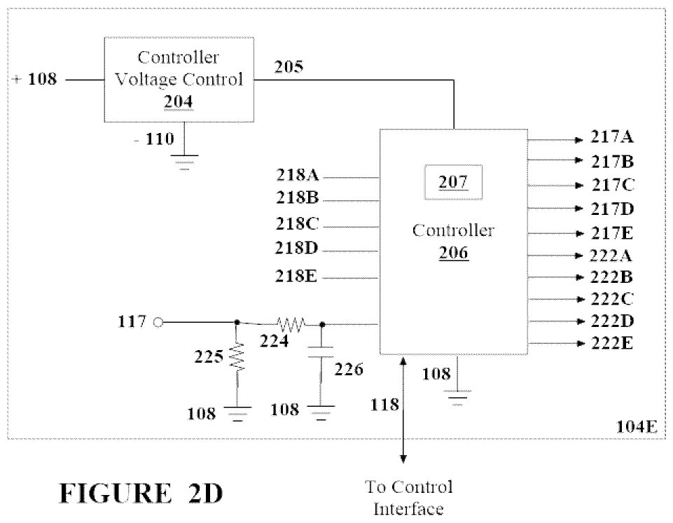

The control apparatus 104A is further described for one embodiment of the present invention with reference to FIGS. 2A and 2B. As shown in FIG. 2A, the control apparatus 104A comprises positive and negative input pins 201, 202 respectively that connect to the constant voltage driver 102 and are connected to positive rail 108 and ground rail 110 respectively. The positive rail 108 in this embodiment is directly connected to the common positive 112, though in other embodiments components may be coupled between them, potentially for filtering. The control apparatus 104A further comprises a capacitor 203 between the positive rail 108 and the ground rail 110.

As shown in FIG. 2B, the control apparatus 104A further comprises a controller voltage control 204 that generates a controller voltage 205 that powers a controller 206.

The controller voltage 205 may be 5V in some embodiments. The controller 206 may receive voltage sense indication 211 and current sense indications 218A, 218B. In response to the voltage sense indication 211, the controller 206 may control a voltage converter PWM signal 210. In response to the current sense indications 218A, 218B, the controller 206 may control voltage converter PWM signals 217A, 217B respectively, which can be used to control the current flowing through CH4 and CH5 respectively. The controller 206 may further output channel PWM signals 215A, 215B, 215C that can control the activation periods within a cycle for CH1, CH2 and CH3. The controller 206 may comprise a memory clement 207 that stores one or more calibration profiles or other data that can be used to set mixes of channels based on inputs received, dimming curves for different channels, and/or other parameters of operation of the controller 206. The controller 206 may further receive a control signal 118 from a control interface. The control interfaces may take many forms including, but not limited to, 0-10V, DMX, DALI, BLE, WiFi, Zigbee, or another wireless or wired control protocol. The control interface may also comprise a local control interface or sensors. The controller 206 further outputs channel shutdown signals 222A, 222B which when activated shutdown channels CH4, CH5 respectively. The controller 206 further is coupled through a voltage divider to the identification pin 117. The controller can use the identification pin 117 along with a reference to determine an aspect of an identification element in the lighting module 106, and then determine information within the memory element 207 to use in operation when controlling the lighting module 106.

The control apparatus 104A further comprises PWM voltage converter 208 and a plurality of PWM control modules 214A, 214B, 214C for each of a plurality of LED channels CH1, CH2, CH3. The PWM voltage converter 208, connected to the positive rail 108 and ground rail 110, receives the voltage converter PWM signal 210 and, in response, outputs a PWM low voltage 209 and the voltage sense voltage 211. The PWM low voltage 209 is used as an input to the PWM control modules 214A, 214B, 214C. The difference between the common positive 112 and the PWM low voltage 209 becomes the voltage applied to each of the LED channels coupled to the return paths 114A, 114B, 114C. The PWM control modules 214A, 214B 214C are operable to activate and deactivate channels CH1, CH2, CH3 within a cycle based on PWM control signals 215A, 215B, 215C respectively. In one implementation, the PWM operates at 31 KHz.

The voltage converters 216A, 216B for CH4 and CH5, connected to the positive rail 108 and ground rail 110, receives the voltage converter PWM signals 217A, 217B respectively and, in response, generates the voltages on return paths 116A, 116B respectively. The difference between the common positive 112 and the return paths 116A, 116B determines the current flowing through CH4 and CH5 respectively.

With reference to FIG. 2C and according to an embodiment of the present disclosure, the control apparatus 104E is similar to the control apparatus 104A of FIG. 2A but instead of using PWM control modules (214A, 214B, 214C in FIG. 2A) and voltage converters (216A, 216B in FIG. 2A), the control apparatus 104E uses five voltage converters 216A, 216B, 216C, 216D, 216E.

With reference to FIG. 2D and according to an embodiment of the present disclosure, the control apparatus 104E is similar to the control apparatus 104A of FIG. 2B but instead of the controller 206 receiving voltage sense indication (211 in FIG. 2B) and only two current sense indications (218A, 218B in FIG. 2B), the controller 206 of the control apparatus 104E receives five current sense indications 218A, 218B, 218C, 218D, 218E. Additionally, based on the five current sense indications 218A, 218B, 218C, 218D, 218E, the controller 206 outputs CCR signals 217A, 217B, 217C, 217D, 217E. The controller 206 further outputs channel shutdown signals 222A, 222B, 22C, 222D, 222E, which when activated, shutdown channels CH1, CH2, CH3, CH4, CH5 respectively. This ensures no leakage current flows through the channels CH1, CH2, CH3, CH4, CH5.

With further reference to FIGS. 1E, 1F, 1G, 2C and 2D, it has been shown that having five CCR channels as opposed to a mix of PWM and CCR is advantageous due to it being flicker-free and having increased energy efficiency. Indeed, in some system architectures, it can be more energy efficient to adjust the input voltage to the LEDs to achieve the desired current (at various dim levels) than it is to force all LED channels to be a fixed voltage and time multiplex the LEDs to dim them.

A worker skilled in the art would appreciate that the block diagrams shown in FIGS. 1A-1G and 2A-2D are merely exemplary and not intended to limit the scope of the disclosure. More particularly, a higher or lower number of channels may be used by the lighting apparatus, with the plurality of these channels having a mix of dimming technologies. More specifically, such dimming technologies may be having all channels utilizing CCR, or all channels utilizing PWM, or the channels utilizing a combination of both CCR and PWM as has been disclosed.

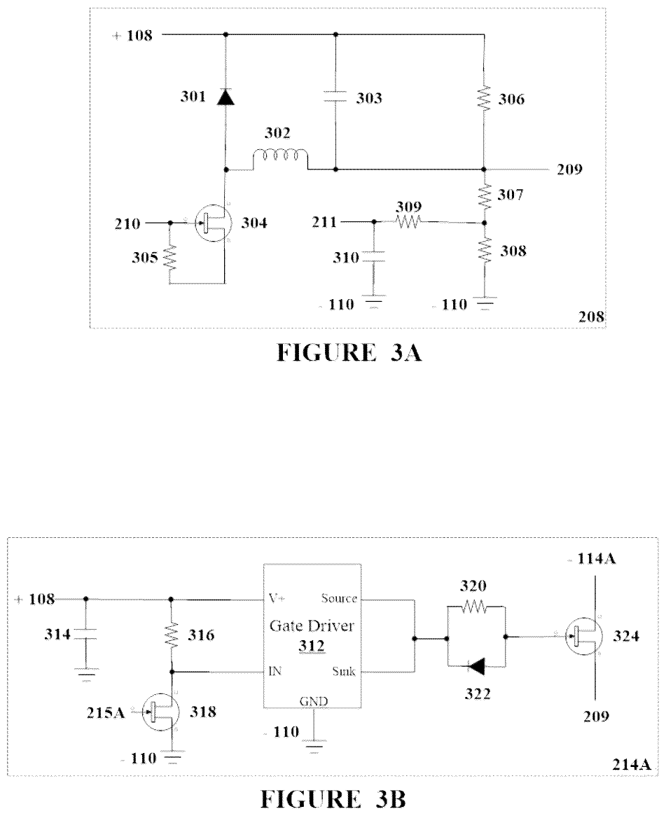

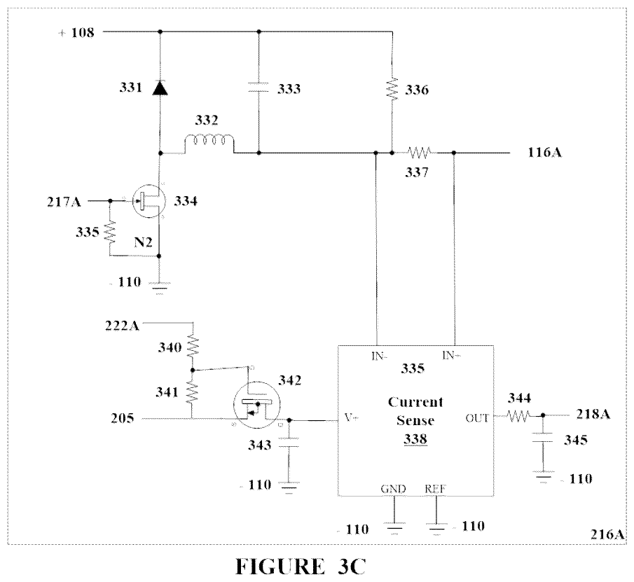

FIGS. 3A, 3B and 3C are sample circuit diagrams of the PWM voltage converter module, PWM control CH1 module, and the voltage converter CH4 module respectively of FIG. 2A. In some embodiments, the PWM signals 210, 217A, 217B controlling any of the voltage converters may use dithering to improve precision of the PWM signals. One implement of dithering within voltage converter control is depicted in U.S. Pat. No. 9,578,704 issued on Feb. 21, 2017 by Briggs, hereby incorporated by reference herein. In some embodiments, the PWM signals 215A, 215B, 215C controlling any of the PWM control modules 214A, 214B, 214C may use dithering to improve precision of the PWM signals. One implement of dithering within PWM dimming control is depicted in U.S. Pat. No. 8,604,713 issued on Dec. 10, 2013 by Briggs, hereby incorporated by reference.

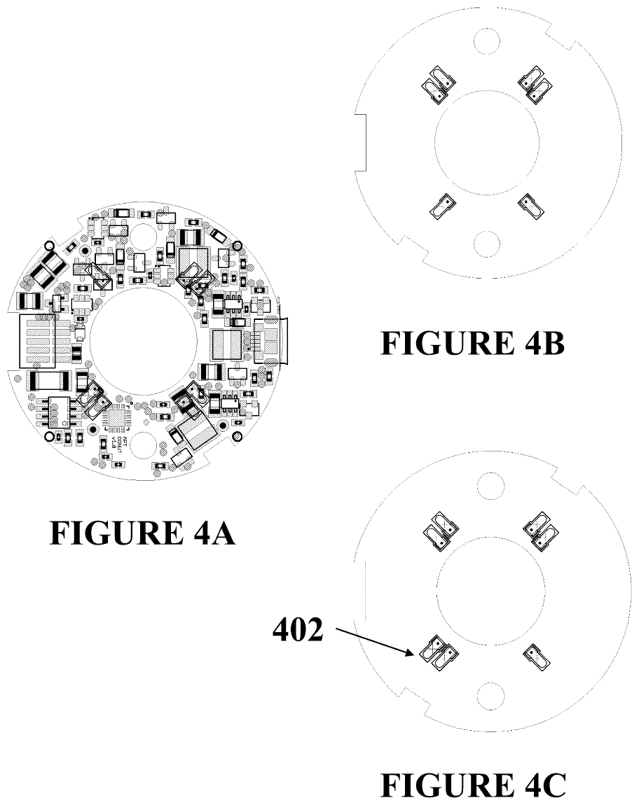

FIGS. 4A and 4B are top and bottom views of a sample implementation of the control apparatus of FIG. 1A and FIG. 4C is a bottom view of a sample implementation of the control apparatus of FIG. 1B. As shown on FIG. 4B, in one implementation, the bottom surface of the control board within the control apparatus comprise six connectors, corresponding to 112, 114A, 114B, 114C, 116A, 116B. As shown in FIG. 4C, in one implementation there is a seventh connector 402 that connects to the identification pin 117.

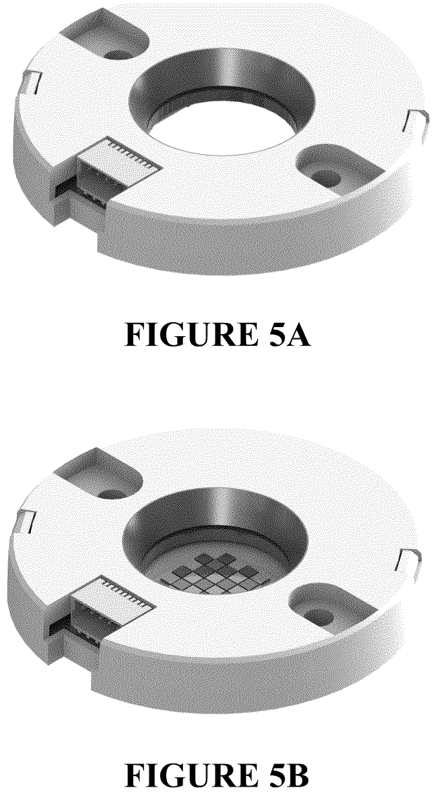

FIG. 5A is a top view of a sample implementation of the control apparatus of FIGS. 4A and 4B after encasement and FIG. 5B is a top view of the sample implementation with the removable LED module included.

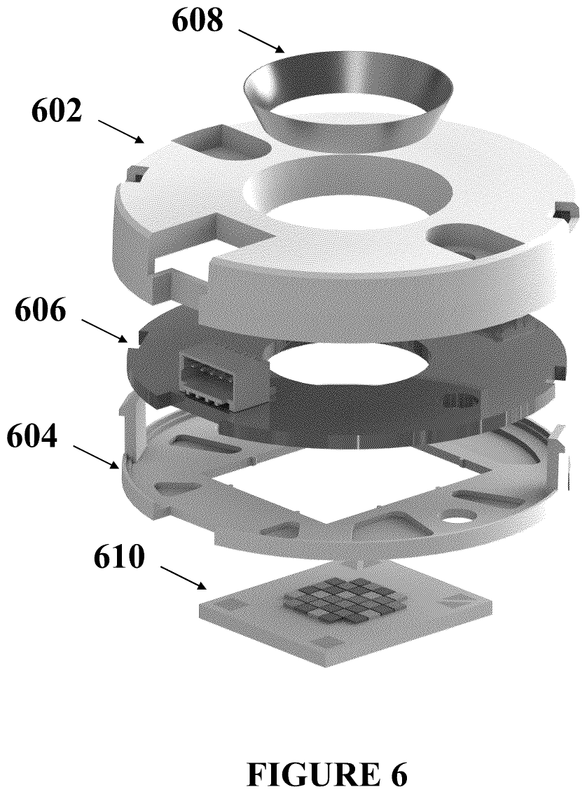

FIG. 6 is a breakout diagram illustrating the elements of FIG. 5B broken out for clarity. This breakout shows top and bottom encasement elements 602, 604 respectively, control board 606, reflector 608 and LED module 610. In this embodiment, there is a hole in the bottom encasement 604 sufficient to enable the LED module 610 to contact the connectors on the bottom surface of the control board 606. The hole is designed in this implementation to be flush with the LED module 610 when connected to the control board 606.

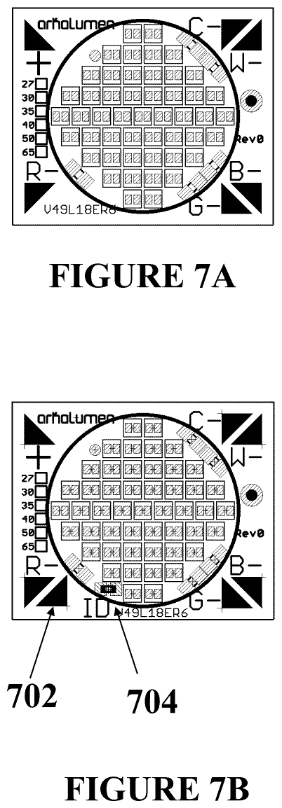

FIG. 7A is a top view of a sample implementation of the lighting module of FIG. 1A and FIG. 7B is a top view of a sample implementation of the lighting module of FIG. 1B in which an ID element 704 is included. In this embodiment, the ID element 704 is connected between ID pin 702 and the common positive 112.

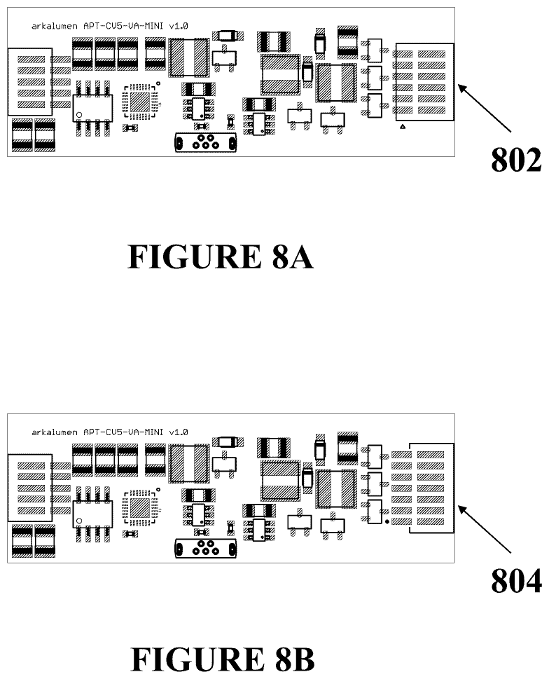

FIGS. 8A and 8B are top views of alternative implementations of the control apparatus of FIGS. 1A and 1B respectively. In these embodiments, the control apparatus is implemented in a linear form factor rather than donut shaped form factor as previously illustrated. In FIG. 8A, the control apparatus has a connector 802 with 6 pins. In FIG. 8B, the control apparatus has a connector 804 with 7 pins to allow for the LED module identification pin 117.

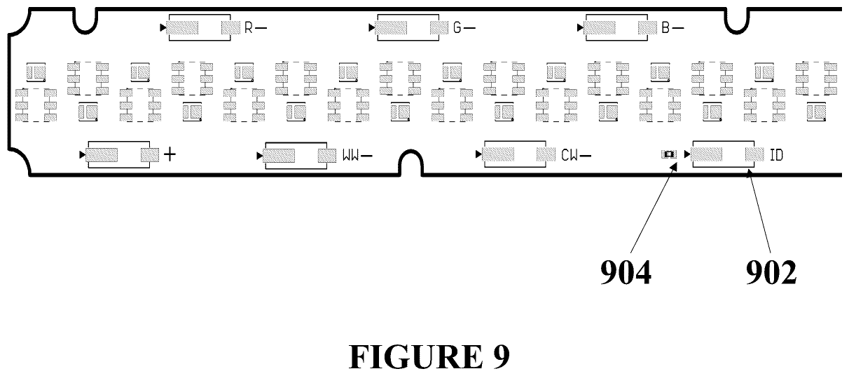

FIG. 9 is an enlarged top view of an alternative sample implementation of a portion of the lighting module of FIG. 1B to better illustrate the ID element 904 and ID pin 902. In this embodiment, the ID pin and element 902, 904 are implemented in a linear LED module rather than the integrated modular architecture as illustrated in FIG. 11. It is understood that the ID element as described in the present disclosure is implementable in a variety of LED modules having a variety of shapes and sizes.

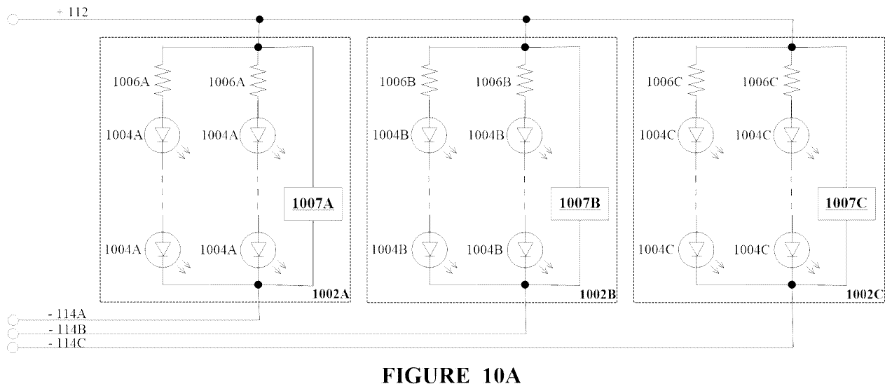

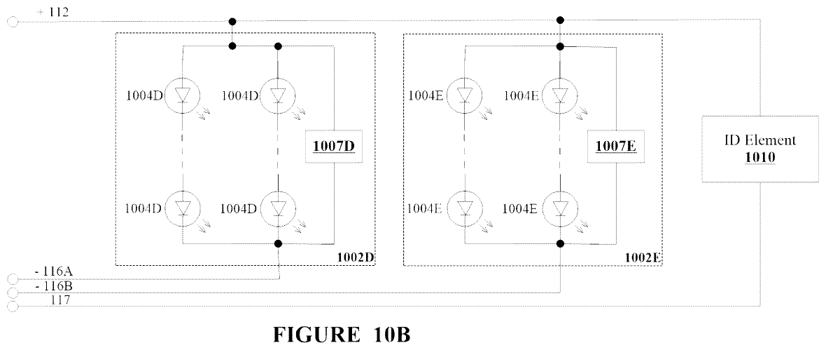

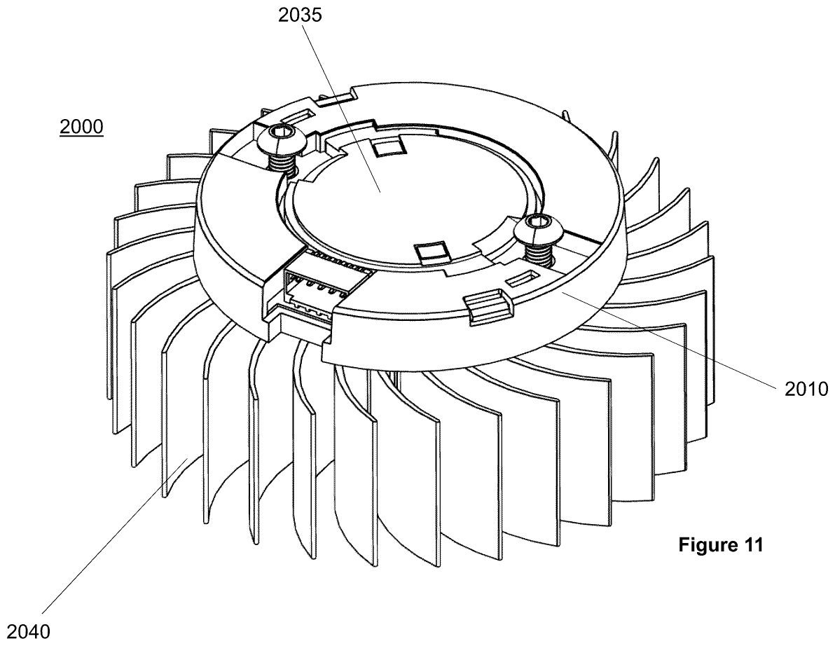

FIGS. 10A and 10B are circuit diagrams of a sample implementation of the lighting module of FIG. 1B. In particular, FIG. 10A shows three different LED groups 1002A, 1002B, 1002C, with LED group 1002A coupled between the common positive 112 and PWM controlled output 114A, LED group 1002B coupled between the common positive 112 and PWM controlled output 114B and LED group 1002C coupled between the common positive 112 and PWM controlled output 114C. LED group 1002A is comprised of two sets of components in parallel with one another and in parallel with an element 1007A, each set of components comprising a resistor 1006A in series with one or more LEDs 1004A. LED group 1002B is comprised of two sets of components in parallel with one another and in parallel with an element 1007B, each set of components comprising a resistor 1006B in series with one or more LEDs 1004B. LED group 1002C is comprised of two sets of components in parallel with one another and in parallel with an element 1007C, each set of components comprising a resistor 1006C in series with one or more LEDs 1004C. Meanwhile, FIG. 10B shows two different LED groups 1002D, 1002E, with LED group 1002D coupled between the common positive 112 and CCR controlled output 116A, and LED group 1002E coupled between the common positive 112 and CCR controlled output 116B. LED group 1002D is comprised of two sets of components in parallel with one another and in parallel with an element 1007D, each set of components comprising one or more LEDs 1004D in series with one another. LED group 1002E is comprised of two sets of components in parallel with one another and in parallel with an element 1007E, each set of components comprising one or more LEDs 1004E in series with one another. The ID element 1010 is coupled between the common position 112 and LED module identification pin 117. Elements 1007A, 1007B, 1007C, 1007D, 1007E are varistors used to protect the LEDs 1004A, 1004B, 1004C, 1004D, 1004E, respectively. The varistors 1007A, 1007B, 1007C, 1007D, 1007E of FIGS. 10A and 10B and the resistors 1006A, 1006B, 1006C in FIG. 10A are optional elements. There may be more or less chains of LEDs 1004A, 1004B, 1004C, 1004D, 1004E and in some embodiments the LED groups 1002A, 1002B, 1002C, 1002E, 1002F may comprise only a single set of LEDs 1004A, 1004B, 1004C, 1004D, 1004E in series. It is understood that in the case of the lighting module of FIG. 1F having five CCR channels, all five CCR channels would be similar to that shown in FIG. 10B. Although FIGS. 10A and 10B illustrate groups of two LEDs (e.g. 1004A, 1004B, 1004C, 1004D, 1004E), such groups of LEDs represent at least one LED in some cases, but in most cases a plurality of LEDs in series. In an embodiment, the number of LEDs 1004A, 1004B, 1004C, 1004D, 1004E in series and the forward voltage of those LEDs 1004A, 1004B, 1004C, 1004D, 1004E will dictate the forward voltage of the LED channel.

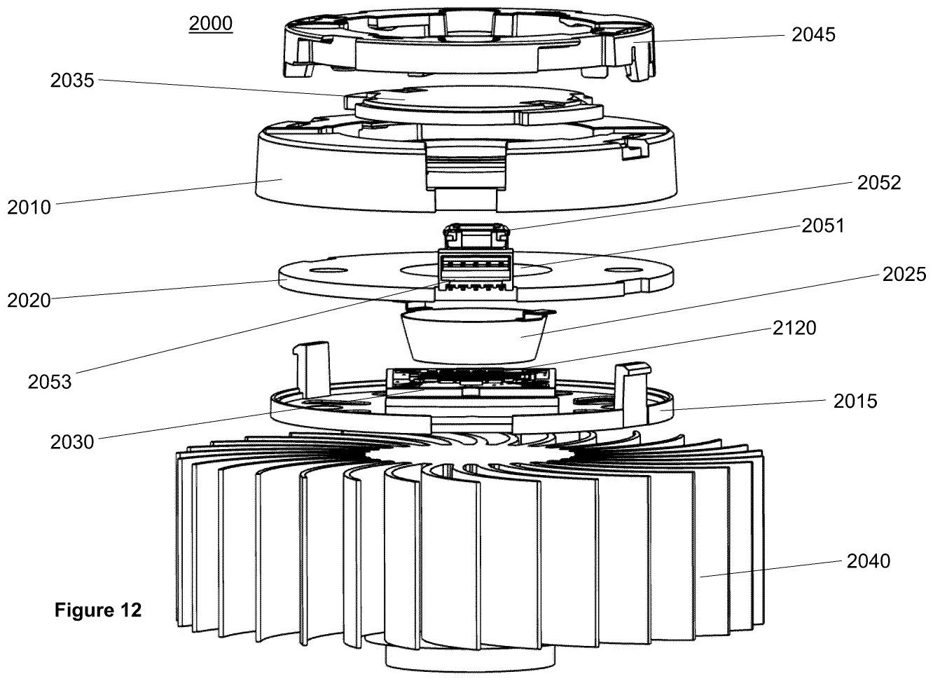

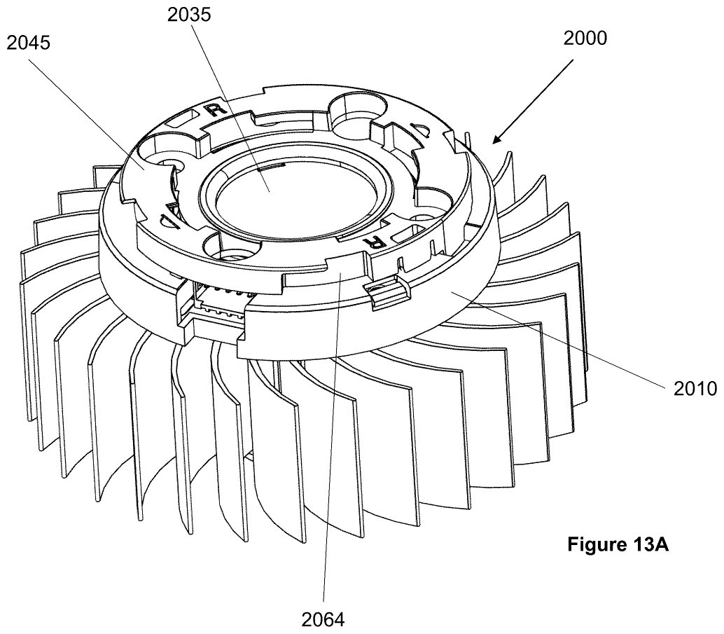

With reference to FIGS. 11 and 12 and according to an embodiment of the present invention, a lighting apparatus 2000 is shown. The lighting apparatus 2000 is generally comprised of top and bottom encasement elements 2010, 2015, control board 2020 also termed control module, optional reflector 2025 and LED module 2030. The lighting apparatus 2000 is further comprised of an optional diffuser 2035 and heat sink element, the heat sink element being a heat sink 2040 securely connected to the control board 2020 and an optional thermal interface element (not shown). Although FIGS. 11 and 12 only show the heat sink 2040, a worker skilled in the art would appreciate that the heat sink 2040 makes contact with the underside of the LED module 2030 through the thermal interface element. Such a thermal interface element (not shown) may be a graphite sheet, thermal paste or other similar element. It should be understood that the thermal interface element (not shown) may not be required and in some instances the underside of the LED module 2030 is flush with the heat sink 2040. The control board 2020 is further comprised of a central aperture 2051 that allows the LED module 2030 to be electrically connected to the control board 2020 from an underside of the control board 2020. In operation, the LED module 2030 projects light through the central aperture 2051 of the control board 2020, within the reflector 2025, through the diffuser 2035 and to a lens or optic (not shown) or other similar component or, in some embodiments, there is no additional optic component. In another embodiment, the lighting apparatus 2000 does not utilize a reflector 2025 and the light from the LEDs 2120 emits upwardly to the lens or optic (not shown) or other similar component or, in some embodiments, there is no additional component. In embodiments where no optic is used, the light from LEDs 2120 simply emits upwardly and out of the apparatus 2000 with minimal or no significant optical control. This may create a wider beam angle, which is desirous in some circumstances. Similarly, in another embodiment, the diffuser 2035 is optional and may integrate directly into the socket 2045 or the top encasement 2010 and may act to diffuse light from the LED module 2030. The lighting apparatus 2000 is also comprised of a USB port 2052 and a 5-pin connector 2053, each of which being in electrical connection with the control board 2020. The USB port 2052 is accessible by a user and would provide access to the control board 2020 for configuration and calibration of lighting apparatus 2000, among other things. The connector 2053 is also accessible by a user and would provide power as well as control for the LED module 2030 of the lighting apparatus 2000 if a wired control protocol is used. In another embodiment, the lighting apparatus 2000 is comprised of a modified connector 2053, for example in some cases when a wireless control protocol is used. In such a case, the connector 2053 may only be comprised of two pins for power, which may be either AC or DC, depending on the electronics of the control board 2020. A worker skilled in the art would appreciate that the control board 2020 is capable of controlling a mix of light from multiple channels to create calibrated lighting effects such as tunable white, tunable colours, dim-to-warm, etc.

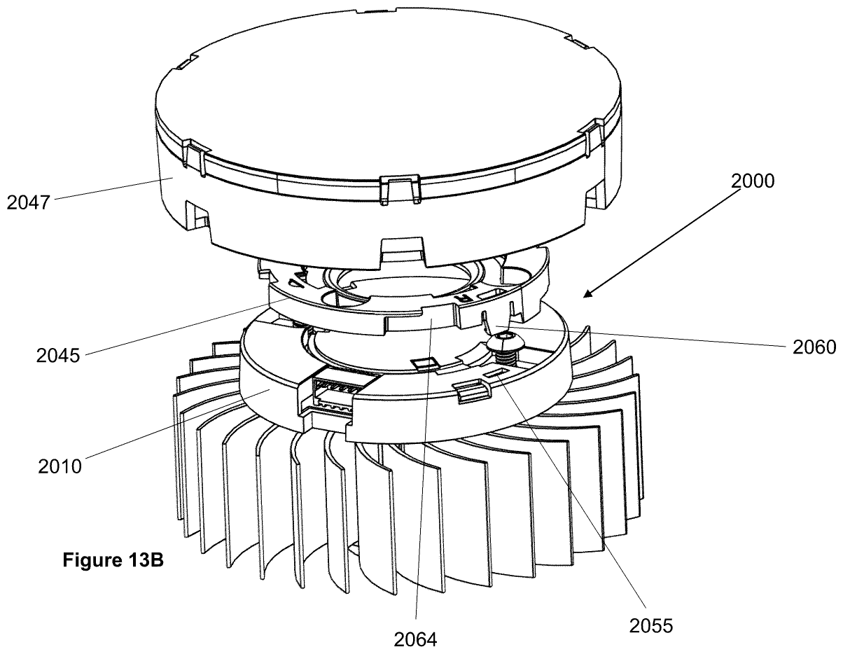

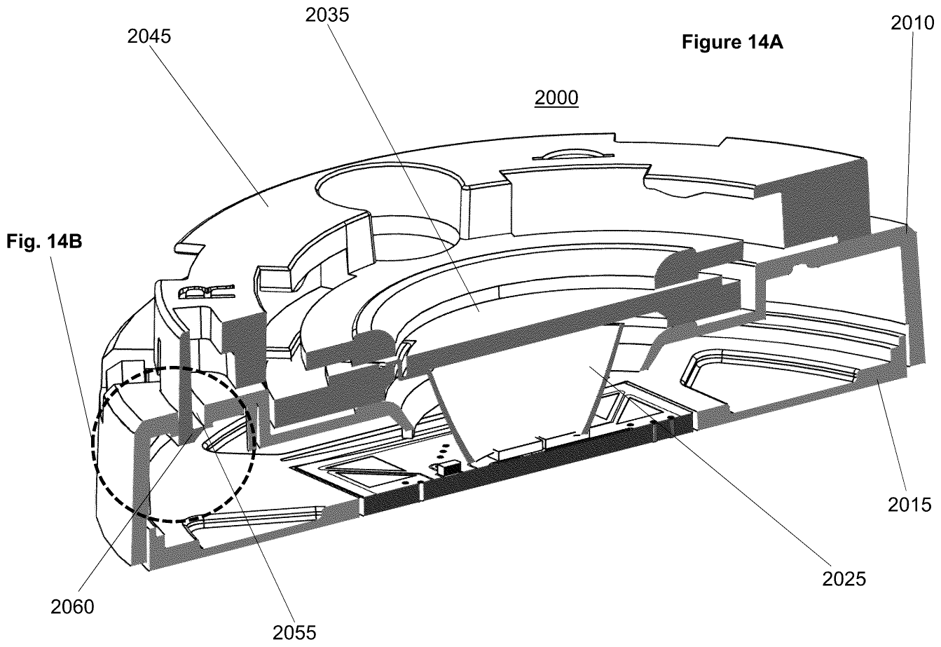

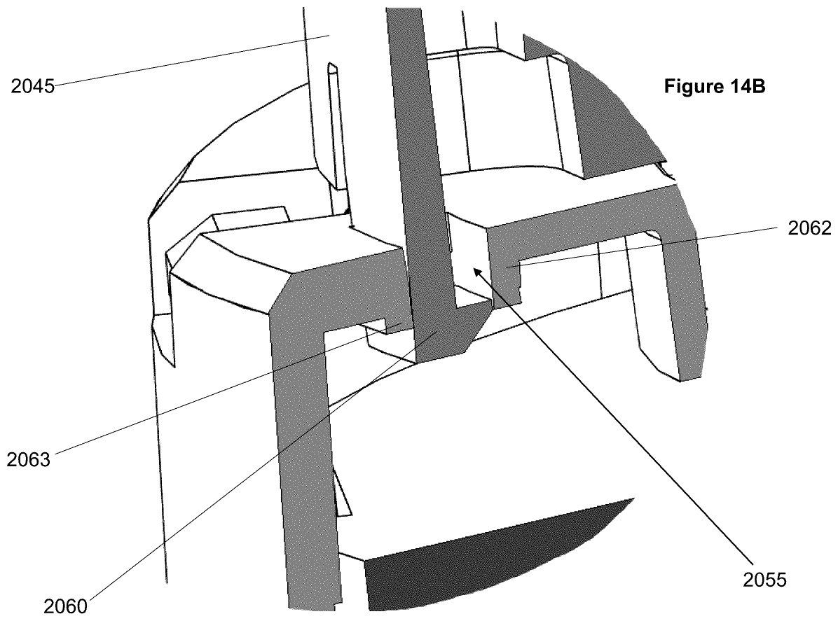

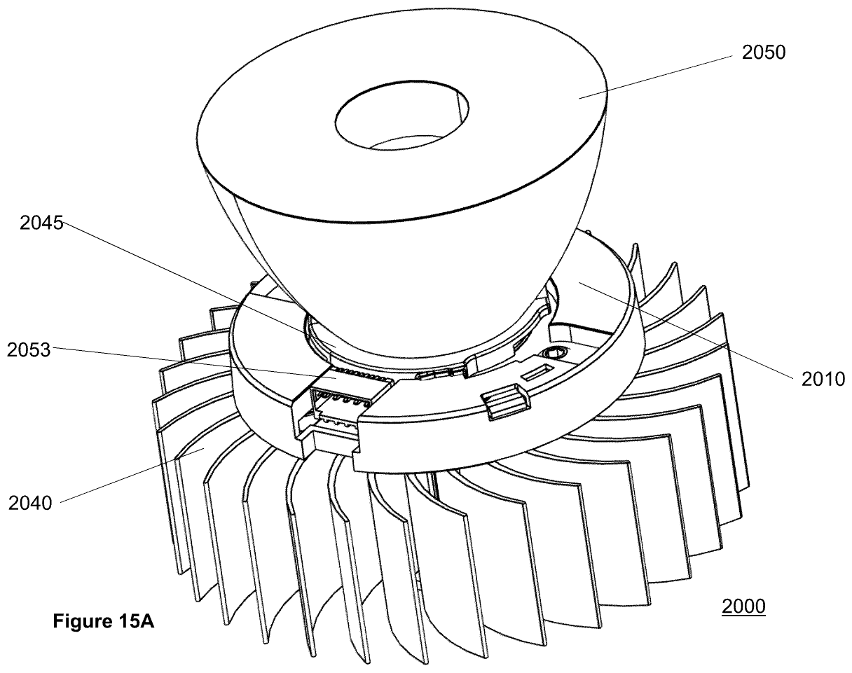

With reference to FIGS. 13A, 13B, 14A and 14B and according to an embodiment of the present invention, the lighting apparatus 2000 is shown connected to a socket 2045 for further attachment to a lens 2047. These sockets 2045 are well-known in the art and have a pair of arms 2060 to releasably clip into a corresponding apparatus (not shown). In a typical arrangement in the art, the pair of arms 2060 can be disengaged by an operator for disconnection between the socket 2045 and apparatus (not shown). However, in this embodiment, the top encasement 2010 has a greater circumference than the circumference of the socket 2045, which does not allow for an operator to disengage the arms 2060 and release the socket 2045. As such, the top encasement 2010 is further comprised of a pair of slits 2055 adapted to receive the pair of arms 2060 of the socket 2045 to releasably secure the socket 2045 to the top encasement 2010. These slits 2055 have a sufficient depth that allows the arms 2060 to remain within the slits 2055 by friction fit. Indeed, the slits 2055 are defined by opposed walls 2062, 2063 extending downwardly and sufficiently for the arms 2060 not to lockably clip into top encasement 2010. Although a friction fit has been described, other securing means are possible without departing from the scope of the disclosure. In other embodiments, the circumference of the top encasement 2010 is smaller than the circumference of the socket 2045, which would allow an operator access to release to disengage the arms 2060. In these other embodiments, the pair of slits 2055 may have a depth allowing the arms 2060 to lockably clip-in and not be friction fit. The socket 2045 has circumferential slots 2064 configured to receive the lens 2047.

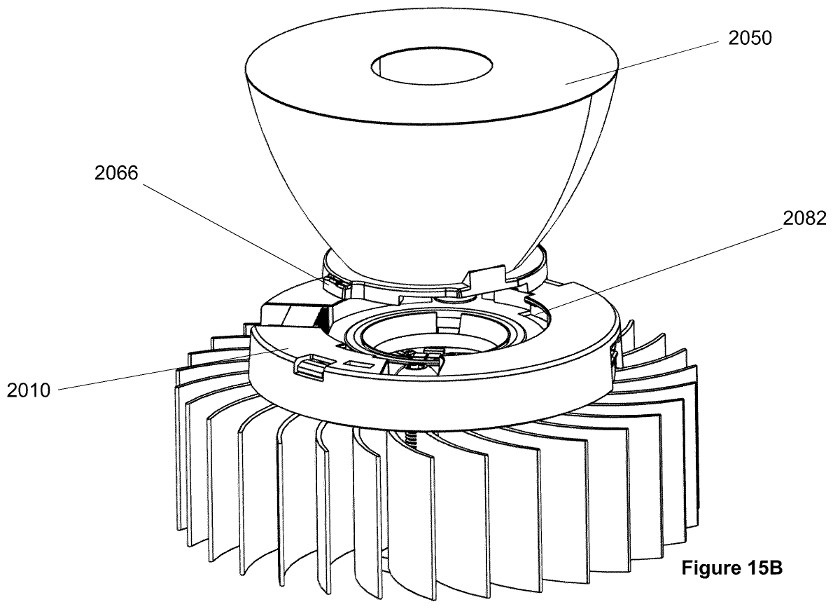

With reference to FIGS. 15A and 15B and according to an embodiment of the present disclosure, a TIR lens 2050 is shown releasably secured to the top encasement 2010. The TIR lens 2050 has a pair of supports 2066 that can twist and lock into a corresponding optic attachment element shown as nooks 2082 of the top encasement 2010. Although the top encasement 2010 is shown connected to a TIR lens 2050, other components can be used, for example other focus optics having similar connecting arrangements.

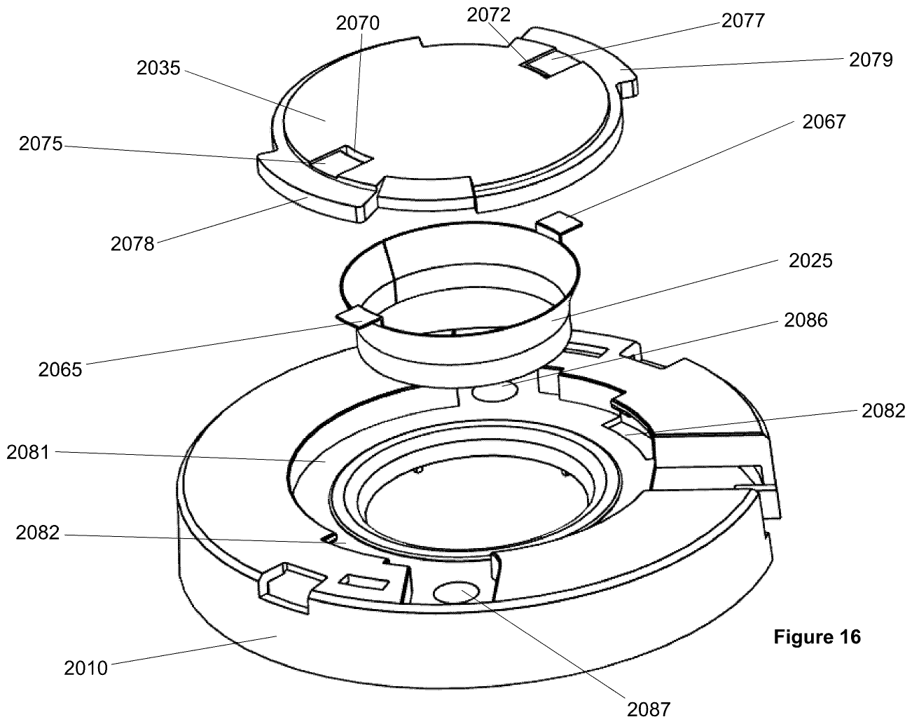

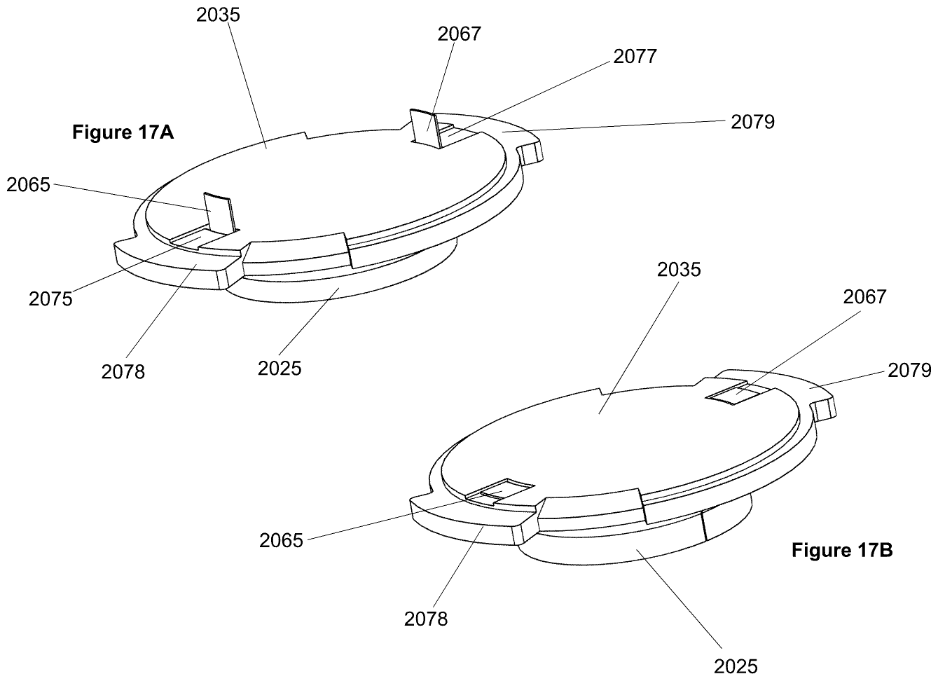

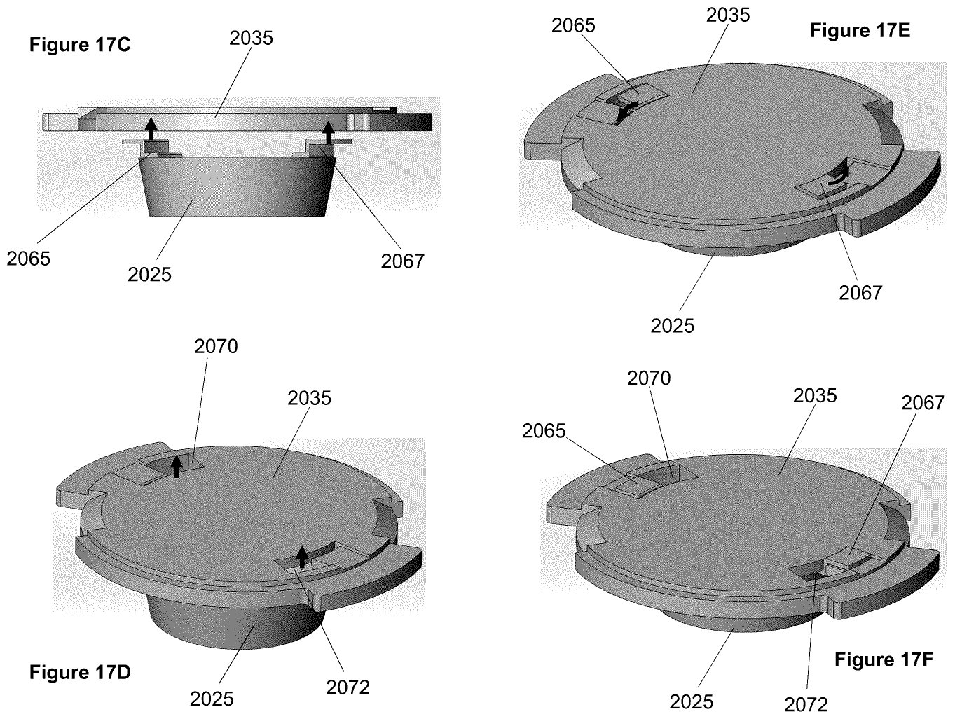

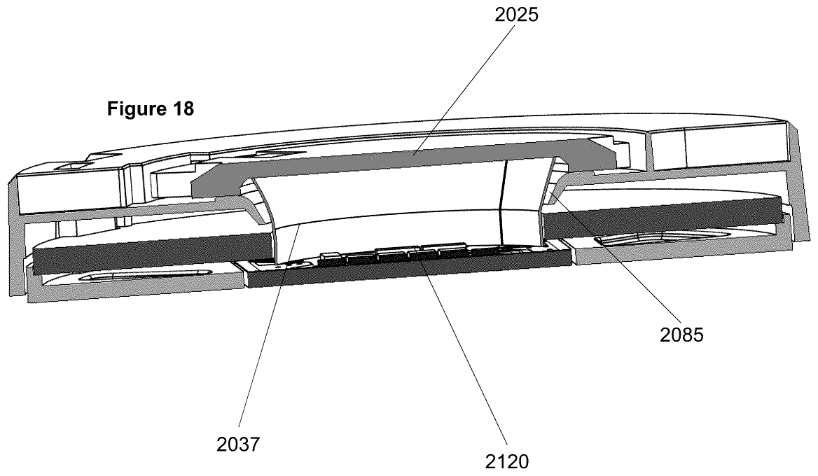

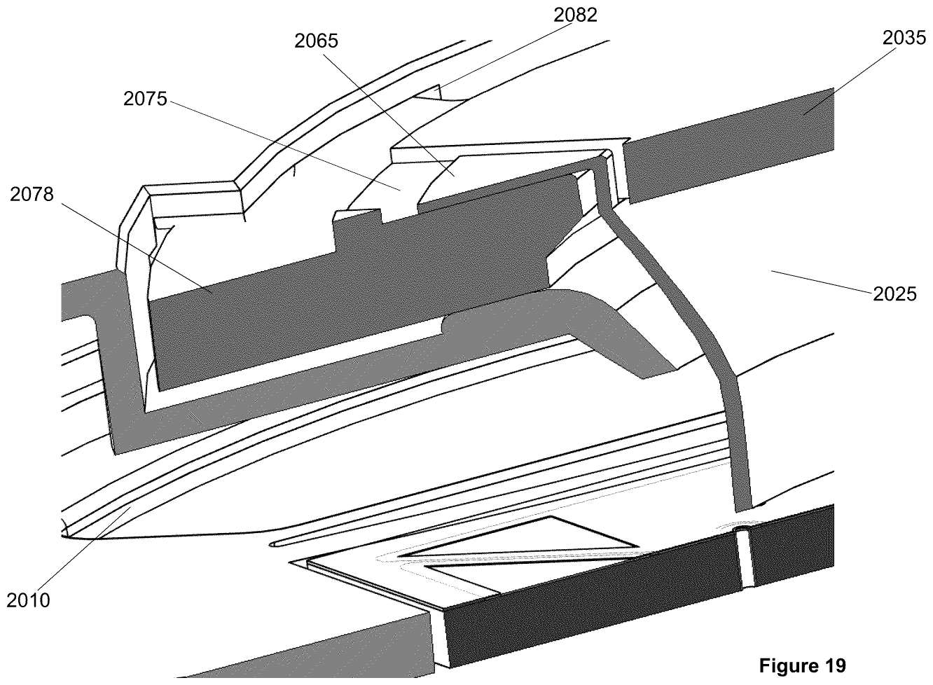

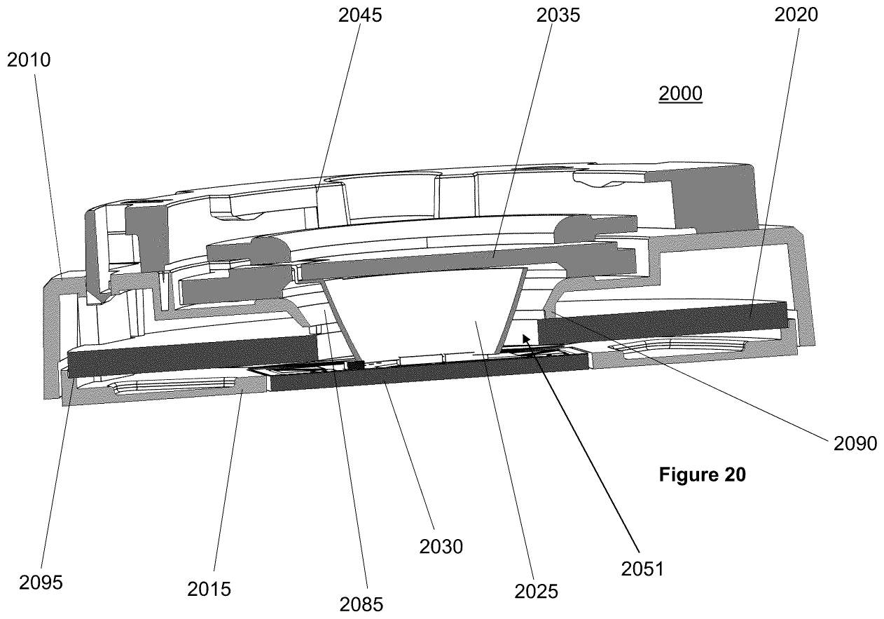

With reference to FIGS. 16, 17A, 17B, 18 and 19 and according to an embodiment of the present invention, the interconnection between the diffuser 2035, reflector 2025 and top encasement 2010 is shown. As shown, the diffuser 2035 is positioned in front of the LEDs 2120 for diffusing the light emitted from the LED module 2030 and the reflector 2025 surrounds the LEDs 2120 and is coupled between the diffuser 2035 and the LED module 2030, the reflector 2025 having a generally cylindrical shape with an outward expanding draft angle. The diffuser 2035 may have a variety of levels of diffusion depending on the application in order to mitigate issues such as pixelization of the LEDs and enable proper mixing of light from discrete LEDs within the LED module 2030. The reflector is generally operable to focus the light of the LED module 2030 and/or mitigate light leakage sideways from the LED module 2030. The reflector 2025 is comprised of engageable tabs 2065, 2067 insertable within openings 2070, 2072 of the diffuser 2035. To secure the diffuser 2035 to the reflector 2025, the tabs 2065, 2067 of the reflector 2025, which are initially in an upward orientation as specifically shown in FIG. 17A, are aligned with and inserted into the openings 2070, 2072 of the diffuser 2035. Once fully inserted, the tabs 2065, 2067 are bent over a stepped portion 2075, 2077 of the diffuser 2035, as best shown in FIG. 17B. In this position, the diffuser 2035 is positioned over and secured to the reflector 2025 and the combination of these elements together form a diffuser-reflector element. The diffuser 2035 is releasably lockable to the top encasement 2010 by positioning notches 2078, 2079 of the diffuser 2035 over an inner face 2081 of the top encasement 2010. The diffuser 2035 is configured to be rotated such that the notches 2078, 2079 are locked within nooks 2082 of the top encasement 2010. This locked state is best shown in FIG. 19 where notch 2078 is rotatably inserted in the nooks 2082. A worker skilled in the art would appreciate that the relationship between the diffuser 2035 and both the top encasement 2010 and reflector 2025 allows for a variety of reflectors 2025 to be utilized. For example, FIG. 18 shows an alternate reflector 2037 with a different shape to provide alternative beam forming and reflection level to the LEDs 2120. The reflector 2037 has a wide lower opening with a lower circumference that is nearly equal to the size of the cavity defined by central sloping inner wall 2085. Meanwhile, the reflector 2035 shown in FIG. 20 has a smaller lower opening with a lower circumference that is narrower than the cavity defined by central sloping inner wall 2085. It is an object of the invention that the reflectors 2035, 2037 are generally cylindrical, and in some embodiments may have a draft angle such that an upper end is wider than a lower end of the reflectors 2035, 2037. Having such a draft angle can assist with optical efficiency of the system. Keeping the draft angle as low as possible can ensure that the light emitting surface (LES) of the LEDs 2120 is only slightly expanded at the upper end of the reflectors 2035, 2037 compared to the lower end of the reflectors 2035, 2037. The size of the LES of the LEDs 2120 at the upper end of the reflectors 2035, 2037 can dictate how tight a beam angle can be achieved with an optic, such as a TIR optic (not shown). In an embodiment, the diffuser 2035 is made of silicone and is flat, although other material compositions, shapes, thicknesses, and levels of diffusion are possible without departing from the scope of the disclosure. For example, diffuser 2035 could be implemented with various plastic or glass materials and/or could include a dome shape. In yet another embodiment, the diffuser 2035 is generally ring- shaped with a pair of positioning notches that connects to and acts as a holder for the reflector 2025. In other words, the diffuser 2035 has a generally circular hole in its center and the light emitted from the LEDs 2120 is reflected by the reflector 2025 but not diffused. In this case, clement 2035 acts a reflector holder and does not diffuse light from the LEDs 2120. Various shapes and sizes of reflectors 2025 are similarly possible and contemplated within the scope of this disclosure. The top encasement 2010 is further comprised of screw holes 2086, 2087 adapted to receive a Zhaga™ compliant lighting component (not shown).

With reference to FIGS. 17C, 17D, 17E and 17F and according to another embodiment, the diffuser 2035 has one or more slots 2072, 2072, adapted to receive one or more corresponding tabs 2065, 2067 of the reflector 2025. These one or more tabs 2065, 2067 rotatably lock into the slots 2070, 2072 as denoted by arrows, to releasably secure the diffuser 2035 to the reflector 2025. The arrows shown in FIGS. 17C-17F denote the path of the reflector 2025 and tabs 2065, 2067 relative to the diffuser 2035 and the slots 2070, 2072 to push the reflector 2025 into the diffuser 2035 and twistedly lock one to the other. In such an embodiment, the reflector 2025 may be constructed of a material that would not necessarily be bendable. The material may comprise metal or plastic, such as metallic, white or other plastic, that may have a variety of reflectance levels. The reflector 2025 can be used to help focus the light emitted from the LEDs 2120 but also can be used to mitigate light leakage. In the case of the reflector 2025 being constructed of plastic, such as a white plastic, the plastic may be used to mitigate light leakage if sufficiently thick while still having a reflectance value. The use of a white colour in the plastic of such a reflector 2025 may mitigate shift in the colour of the light, which may be desirable in some circumstances.

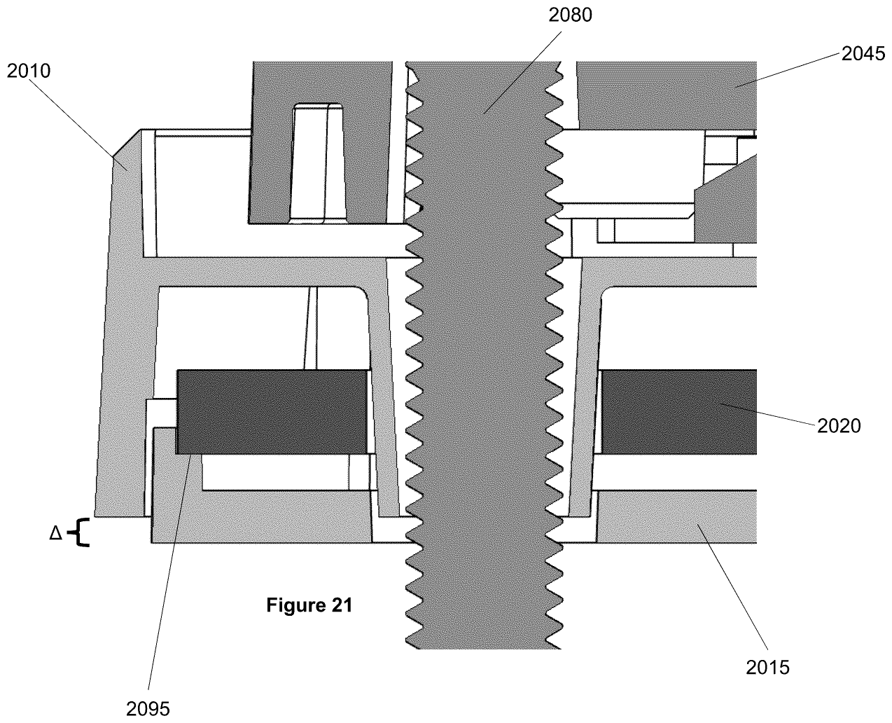

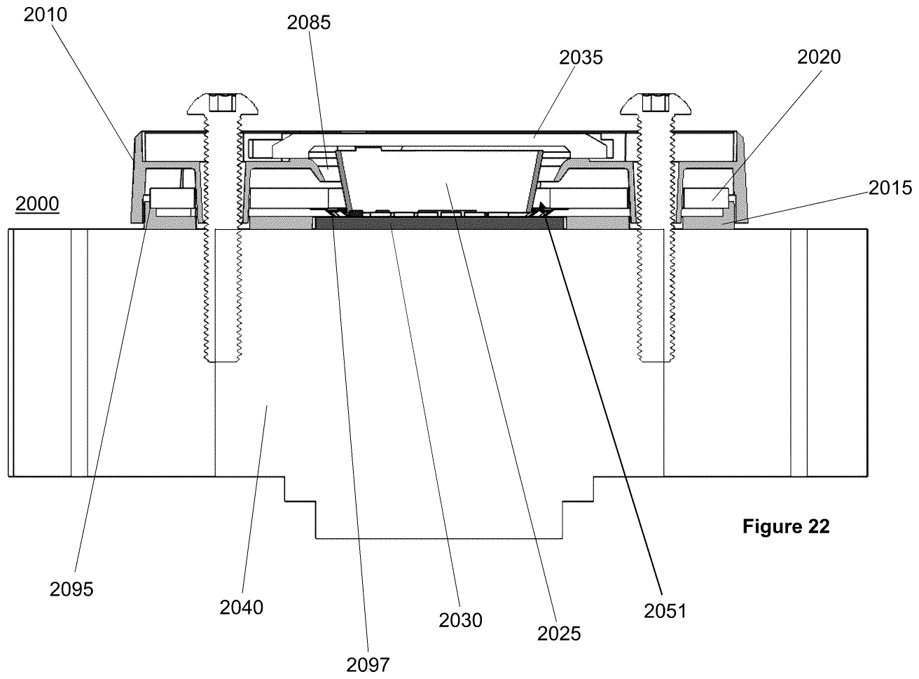

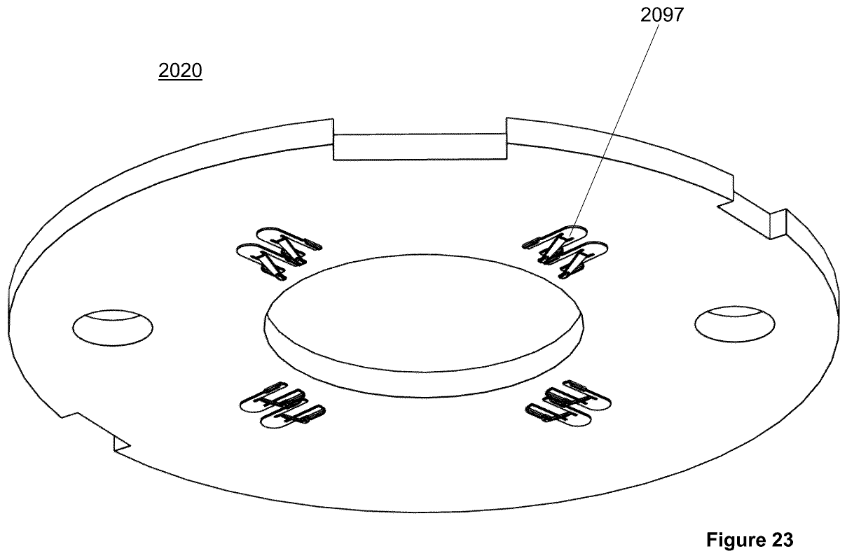

With reference to FIGS. 20, 21, 22 and 23 and according to an embodiment of the present invention, the interconnection between the top and bottom encasements 2010, 2015 is shown. When the lighting apparatus 2000 is assembled, one or more bolts 2080 are fastened into and through the socket 2045, top encasement 2010, bottom encasement 2015 and heat sink (not shown) to hold the components together. The reflector 2025 is positioned generally in the center of the lighting apparatus 2000, over the LED module 2030. The top encasement 2010 is comprised of a central sloping inner wall 2085 defining a cavity through which is positioned the reflector 2025. Similarly, the control board 2020 has a central aperture 2051 through which is positioned the reflector 2025 so that the reflector 2025 is directly above the LED module 2030. The central sloping inner wall 2085 of the top encasement 2010 terminates in feet 2090, which abut against the control board 2020. In turn, the control board 2020 sits flushly on a peripheral edge 2095 of the bottom encasement 2015. In this way, the bottom encasement 2015 is not directly connected to the top encasement 2010. When the lighting apparatus 2000 is assembled, the top and bottom encasements 2010, 2015 define an adjustable offset Δ. Further tightening of the bolts 2080 decreases the offset Δ, whereas further loosening of the bolts 2080 increases the offset Δ. This adjustable offset Δ between the top and bottom encasements 2010, 2015 is advantageous as it addresses common tolerance issues in the plastic, control board 2020, LED module 2030 and other components. Indeed, due to variability and tolerances of the plastic, control board 2020, the LED module 2030 and other electrical components, a problem could occur in which the pins on the control board 2020 and LED module 2030 may get disconnected. As such, it is desirous in some embodiments to have the top and bottom encasements 2010, 2015 not securely connected to one another and provide an adjustable offset Δ between the top and bottom encasements 2010, 2015. The adjustable offset Δ also ensures that the LED module 2030 is flush with the heat sink 2040, thereby improving the thermal connection therebetween. In an embodiment as specifically shown in FIG. 23, the pins of the control board 2020 may be further comprised of a spring element 2097 such as a small spring, coil PCB spring contact or bendable arm to allow for variance in the height of the pins. In the illustrated embodiment, the spring clement 2097 is an angular metal arm that flexes according on the pressure between the LED module 2030 and control board 2020. This variance helps ensure that the electrical connection between the pins of the control board 2020 and the pins of the LED module 2030 is maintained as the LED module 2030 is coupled between the underside surface of the control board 2020 and the heat sink element.

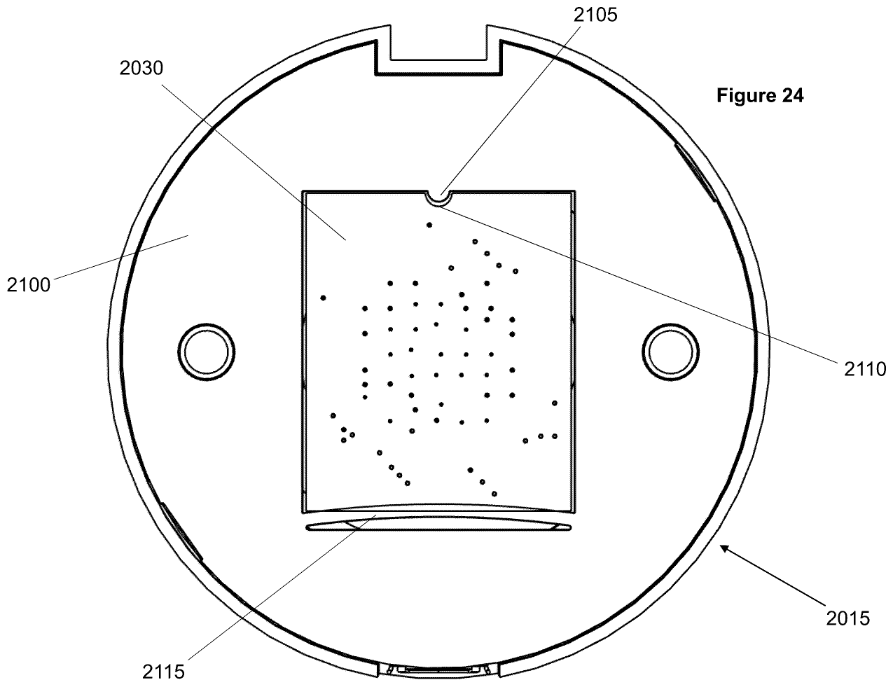

With reference to FIG. 24 and according to an embodiment of the present invention, the underside 2100 of the bottom encasement 2015 is shown. The underside 2100 defines a central hole configured to receive the LED module 2030. In FIG. 24, the central hole is a rectangular hole and the LED module 2030 is coupled within the central hole. In one embodiment, the rectangular hole is 20 mm×24 mm in size, though other dimensions could be used. The underside 2100 is comprised of an alignment notch 2105 corresponding to a groove 2110 in the LED module 2030 to ensure proper alignment of the LED module 2030 within the bottom encasement 2015. The bottom encasement 2015 is also comprised of a convex arm 2115 extending from one side of the central hole to the other, opposed side. The convex arm 2115 is flexible and bends to exert pressure onto the LED module 2030 to hold the LED module 2030 in place within the central hole of the bottom encasement 2015.

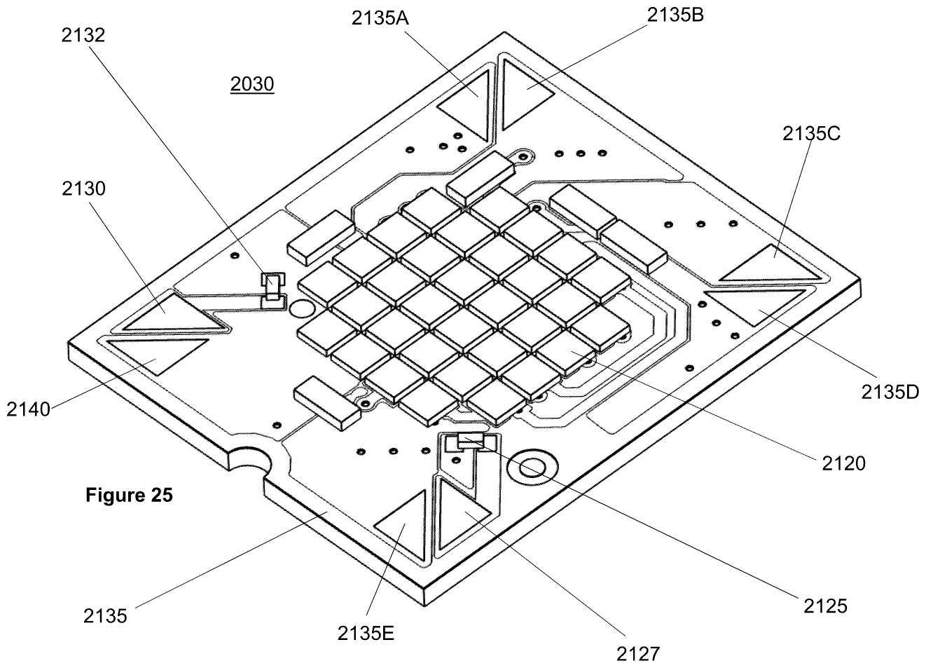

With reference to FIG. 25 and according to an embodiment of the present disclosure, the LED module 2030 has a plurality of pins, the pins positioned on an upper surface of the LED module 2030. The pins include a passive electrical component (identification) pin 2127 such as a resistor, a thermistor pin 2130, a plurality of LED return pins 2135A, 2135B, 2135C, 2135D, 2135E and common positive pin 2140. As shown, the passive electrical component 2125 used for identification is electrically coupled in between the passive electrical component pin 2127 and the common positive pin 2140, whereas the thermistor 2132 used for thermal safety is electrically coupled in between the thermistor pin 2130 and the common positive 2140. The current for each LED channel flows from the common positive pin 2140 and each of the LED return pins 2135A, 2135B, 2135C, 2135D, 2135E. A worker skilled in the art would appreciate that the LED return pins 2135A, 2135B, 2135C, 2135D, 2135E correspond to the channels of the LEDs 2120. In this embodiment, the thermistor 2132 is used as a thermal safety feature. The thermistor 2132 is electrically connected to the controller (not shown) and the controller (not shown) may actuate the LED module 2030 based on the value of the thermistor pin 2130 as detected. For example, the controller (not shown) may trigger safety features (e.g. reducing current to one or more of the LED channels on the LED module 2030, turning off the LED module 2030, etc).

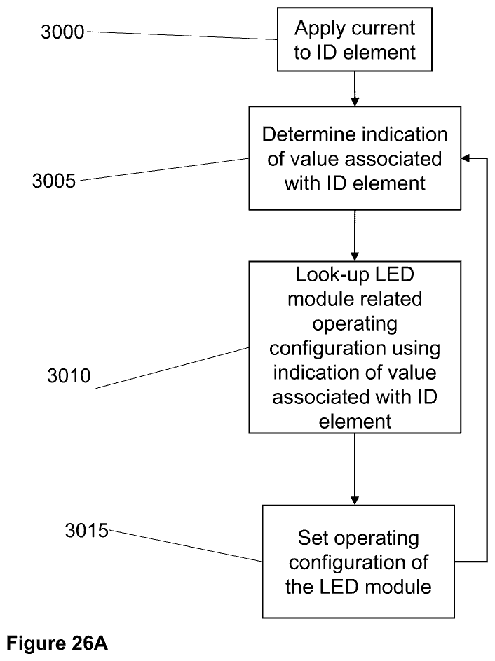

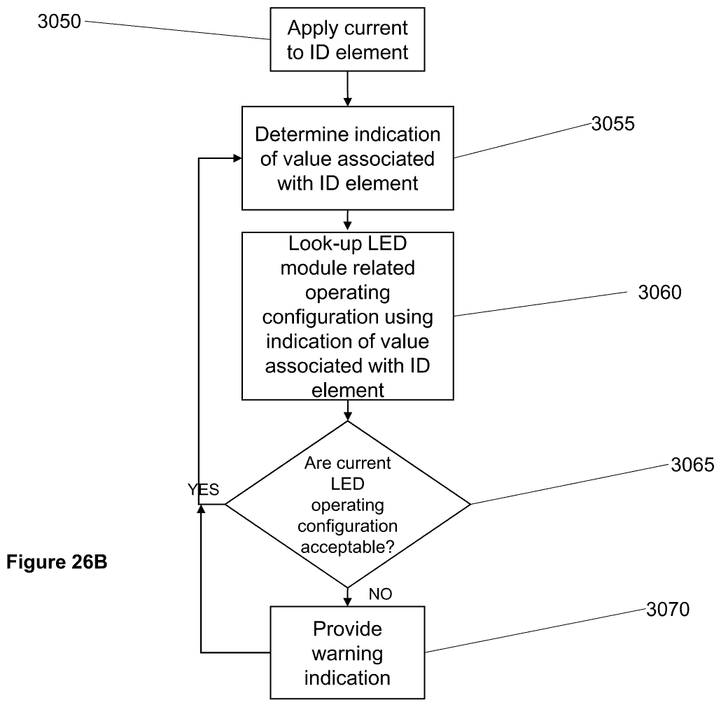

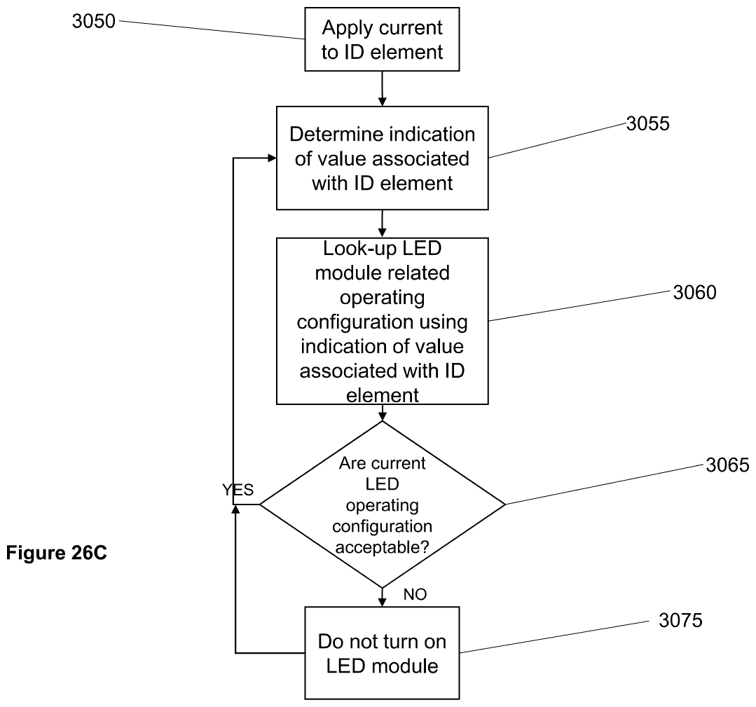

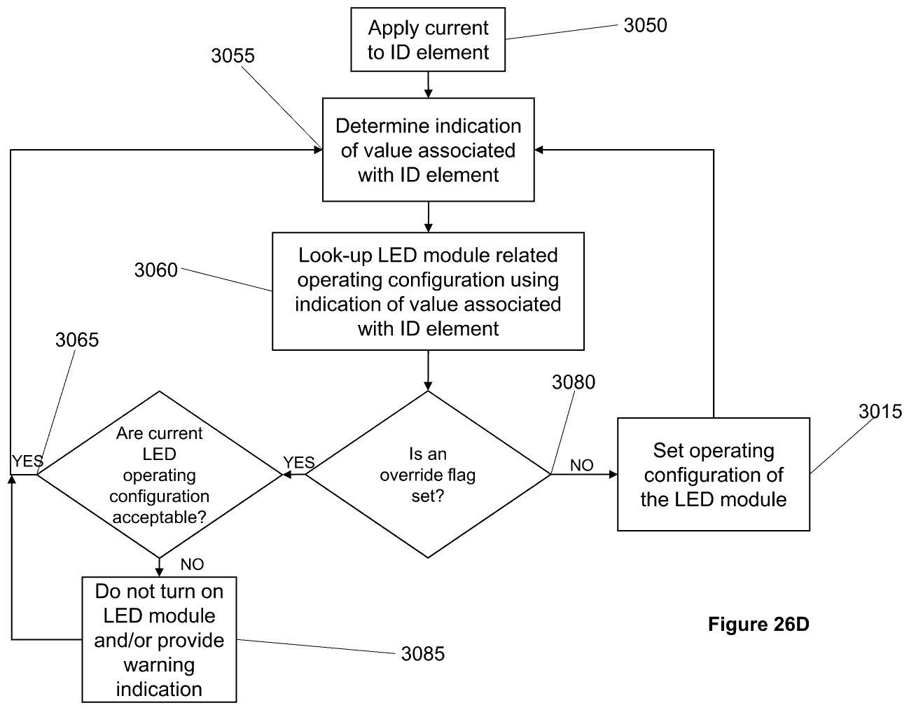

With further reference to FIGS. 2B and 12 and with reference to FIGS. 25, 26A, 26B, 26C, 26D and according to an embodiment of the present invention, an exemplary embodiment of the LED module 2030 is described, along with an autodetection process as performed by a controller, for example by the controller 206. As shown, the LED module 2030 is comprised of a plurality of LEDs 2120. The LED module 2030 is also comprised of a passive electrical component 2125 to provide additional data to the controller 206. The electrical component 2125 is electrically engaged with an identification pin 117 on the controller 206. Although the present invention describes the electrical component 2125 as a resistor, other passive components could be utilized without departing from the scope of the invention.

As shown in FIG. 26A, when the lighting apparatus is activated, the controller 206 applies a current to the electrical component 2125 at step 3000. Once the current has been applied in step 3000, the controller 206 determines a value associated with the electrical component 2125 at step 3005. In the embodiment where the electrical component 2125 is a resistor, this value may be the voltage drop across the resistor as sensed by the controller 206 based on the applied current. Alternatively, the value associated with the electrical component 2125 may be a current through the electrical component 2125 sensed by the controller 206 based on an applied voltage. The controller 206 then looks up the related operating configuration of the LED module 2030, based on the value associated with the electrical component 2125 at step 3010. The related operating configuration is varied but may include: the number of channels on the LED module 2030, maximum currents for each of the LED channels, calibration look-up tables for the mixing of the LED channels to achieve a desired lighting affect (e.g. a particular CCT with a high color rendering index (CRI)), voltages required for the LED channels, a network identifier (ex. DMX address or other control protocol address) that could be used by the controller 206 to identify the lighting apparatus on a network. Indeed, a plurality of other LED module 2030 characteristics may be determined by the controller 206 based on the value associated with the electrical component 2125. In the present embodiment, a memory element such as an EPROM on the control apparatus can store a plurality of different operating configuration information for different LED modules 2030. Should the memory element have sufficient memory, an EPROM would not be necessary. In an embodiment, the look-up table and the operating configuration information for each LED module 2030 could be stored on a microcontroller, a discrete memory component, or even be accessed through a network by the controller 206. Once the related operating configuration of the LED module 2030 has been determined, the controller 206 may set an operating configuration of the LED module 2030 at step 3015. The controller 206 is configured so that it may use the information from the look-up table to set maximum currents and the CCT calibration table. The maximum currents and CCT calibration table affect the response to inputs from the user and ensure the safe use of the LED module 2030, by not exceeding maximum currents for the LEDs 2120, or creating uncontrolled thermal conditions, for example. In an embodiment, once the operating configuration has been set, the controller 206 resumes monitoring the value associated with the electrical component 2125 to detect any changes. In another embodiment, there may not be a feedback loop and the controller 206 may only perform step 3005 once on each startup or only upon initial startup. It is understood that different resistance values of the electrical component 2125 may be used to identify different LED modules 2030, these different LED modules 2030 having different operating configurations. The controller 206 is configured to determine an identification indication (i.e. value) related to the electrical component 2125 by determining a voltage drop across the electrical component 2125 with a particular applied input current. The value determined can be used in the look-up table to determine the operating configuration for the LED module 2030 To determine the identification indication, the control apparatus may be comprised of an analog to digital converter (ADC) with sufficient resolution to distinguish between various voltages that can be used to determine the voltage drop across the electrical component 2125 which in turn is an indication of the resistance value of the electrical component 2125. With this determination of the voltage at the ADC, the different LED modules 2030 can be identified and distinguished.

With specific reference to FIG. 26B and according to another embodiment of the present disclosure, when the lighting apparatus is activated, the controller 206 applies a current to the electrical component 2125 at step 3050. Once the current has been applied in step 3050, the controller 206 determines a value associated with the electrical component 2125 at step 3055. The controller 206 then looks up the related operating configuration of the LED module 2030, based on the value associated with the electrical component 2125 at step 3060. In this particular embodiment, the controller 206 only uses the operating configuration of the LED module 2030 to determine if the operation of the LED module 2030 is acceptable at step 2065. By way of example not intended to be limiting, such acceptable operation of the LED module 2030 may be if it can be safely operated, or if it is within manufacturer specification, etc. If it is determined that the operating configuration of the LED module 2030 is not acceptable, the controller 207 may provide a warning indication at step 3070. The warning indication could take many forms, for example, turning on one or more particular LED channels in a distinct manner (e.g. blinking red light, another color light turning on in a pattern, or all lights turning on at a low intensity level, etc.). Alternatively, a warning indication may be sent through a network to a remote master controller (e.g. sending an error message through remote device management (RDM) protocol). Once the warning indication has been provided in step 3070 or if the LED has been found to be operating in an acceptable configuration in step 3065, the controller 206 would loop back to step 3055 and resume monitoring the value associated with the electrical component 2125 to detect any changes. In another embodiment, there may not be a feedback loop and the controller 206 may only perform step 3055 once on each startup or only upon initial startup.

With specific reference to FIG. 26C, the same steps 3050, 3055, 3060, 3065 would be present. However, if it is determined that the operating configuration of the LED module 2030 is not acceptable, the controller 206 may instead not turn on the LED module 2030 at step 3075. This may be done to prevent further issues with the LED module 2030 from occurring.

With specific reference to FIG. 26D, the same steps 3050, 3055, 3060 would be present. However, the lighting apparatus is configured to allow a user to use a programmer to set the operating configuration for the controller 206, through one of many methods including, but not limited to, using a user interface on a computing device connected wirelessly or wired to the controller 206. The programmer would allow a user to disable the auto calibration that is usually provided by the electrical component 2125 and instead use a programmed configuration. In such an embodiment, the controller 206 may use the electrical component 2125 along with the programmed configuration that may include an override flag to determine what to do with the operating configuration information associated with the LED module 2030. In such an instance, the controller 206 would determine whether an override flag has been set at step 3080. If not, the controller 206 would set an operating configuration of the LED module 2030 as had been done at step 3015. If an override flag has been set, the controller 206 may at minimum confirm that the programmed operating configuration for the LED module 2030, as set by the user in the programmer, is acceptable for the LED module 2030 that has been inserted into the control apparatus at step 3065. If not, the controller 206 could send a warning indication and/or not turn on the LED module 2030 at step 3085. In another embodiment, the controller 206 may not use the electrical component 2125 at all and the controller 206 would use a factory set configuration or the programmed configuration when controlling the LED module 2030.

It is understood that a feature of the present invention is that a variety of different LED modules 2030 can be used with the lighting apparatus (not shown). These various LED modules 2030 can provide a variety of lighting effects.

A worker skilled in the art would appreciate that the features as described in the present disclosure may apply to other lighting module controller circuitry, such as the circuitry described in U.S. Pat. Nos. 9,992,829 (Briggs et al.) and 10,225,904 (Murray et al.), which is incorporated herein by reference. Indeed, these controller circuits may be implemented herein utilizing the present architecture, including but not limited to the presently described passive electrical component and associated identification circuitry, or the presently described lighting apparatus and associated mechanical components.

Although various embodiments of the present invention have been described and illustrated, it will be apparent to those skilled in the art that numerous modifications and variations can be made without departing from the scope of the invention, which is defined in the appended claims.

1. A lighting apparatus comprising:
a light emitting diode (LED) module comprising:
one or more LEDs to emit light; and
an identification element; and
a control apparatus electrically coupled to the LED module, the control apparatus operable to determine an identification indication related to the identification element and to control the LED module at least in part in response to the identification indication.

2. The lighting apparatus of claim 1, wherein the identification element is a passive electrical component.

3. The lighting apparatus of claim 2, wherein the passive electronic component is a resistor with a particular resistance value.

4. The lighting apparatus of claim 3, wherein to determine the identification indication, the control apparatus is operable to determine a voltage drop across the resistor.

5. The lighting apparatus of claim 1, wherein, to control the LED module, the control module is operable to determine an operating configuration for the LED module at least in part in response to the identification indication and to control the LED module at least in part in response to the operating configuration for the LED module.

6. The lighting apparatus of claim 5, wherein the operating configuration comprises at least a maximum current to apply to the LED module; and wherein, to control the LED module, the control module is further operable to control the LED module to ensure the current applied to the LED module is less than or equal to the maximum current.

7. The lighting apparatus of claim 5, wherein the LED module comprises a plurality of LED channels; wherein the operating configuration comprises at least a respective maximum current to apply to each of the LED channels; and wherein, to control the LED module, the control module is further operable to control each of the LED channels to ensure the current applied to each of the LED channels is less than or equal to the respective maximum current.

8. The lighting apparatus of claim 5, wherein the LED module comprises a plurality of LED channels; and the operating configuration comprises at least calibration information related to a mix of the plurality of LED channels required to achieve a particular lighting effect; wherein, to control the LED module, the control module is further operable to control the LED channels to achieve the particular lighting effect.

9. The lighting apparatus of claim 5, wherein the operating configuration comprises at least a predetermined voltage to apply to the LED module; wherein, to control the LED module, the control module is further operable to control the LED channels to set a voltage to apply to the LED module to the predetermined voltage.

10. The lighting apparatus of claim 5, wherein the operating configuration comprises at least a network identifier for the lighting apparatus; wherein, to control the LED module, the control module is further operable to control the LED module in response to communications on a network using the network identifier.

11. The lighting apparatus of claim 5, wherein, to control the LED module, the control module is further operable to determine if a programmed configuration of the control module is acceptable considering the operating configuration of the LED module; and, if the programmed configuration of the control module is not acceptable considering the operating configuration of the LED module, to control the LED module to at least one of provide a warning indication; and disable the LED module.

12. A control apparatus operable to be coupled within a lighting apparatus comprising a light emitting diode (LED) module further comprising: one or more LEDs to emit light; and an identification element; the control apparatus comprising:
a control module, configured to be electrically coupled to the LED module, the control module operable to determine an identification indication related to the identification element and to control the LED module at least in part in response to the identification indication.

13. The control apparatus of claim 12, wherein, to control the LED module, the control module is operable to determine an operating configuration for the LED module at least in part in response to the identification indication and to control the LED module at least in part in response to the operating configuration for the LED module.

14. The control apparatus of claim 13, wherein the operating configuration comprises at least a maximum current to apply to the LED module; and wherein, to control the LED module, the control module is further operable to control the LED module to ensure the current applied to the LED module is less than or equal to the maximum current.

15. The control apparatus of claim 13, wherein the LED module comprises a plurality of LED channels; wherein the operating configuration comprises at least a respective maximum current to apply to each of the LED channels; and wherein, to control the LED module, the control module is further operable to control each of the LED channels to ensure the current applied to each of the LED channels is less than or equal to the respective maximum current.

16. The control apparatus of claim 13, wherein the LED module comprises a plurality of LED channels; and the operating configuration comprises at least calibration information related to a mix of the plurality of LED channels required to achieve a particular lighting effect; wherein, to control the LED module, the control module is further operable to control the LED channels to achieve the particular lighting effect.

17. The control apparatus of claim 13, wherein the operating configuration comprises at least a predetermined voltage to apply to the LED module; wherein, to control the LED module, the control module is further operable to control the LED channels to set a voltage to apply to the LED module to the predetermined voltage.

18. The control apparatus of claim 13, wherein the operating configuration comprises at least a network identifier for the lighting apparatus; wherein, to control the LED module, the control module is further operable to control the LED module in response to communications on a network using the network identifier.

19. The control apparatus of claim 13, wherein, to control the LED module, the control module is further operable to determine if a programmed configuration of the control module is acceptable considering the operating configuration of the LED module; and, if the programmed configuration of the control module is not acceptable considering the operating configuration of the LED module, to control the LED module to at least one of provide a warning indication; and disable the LED module.

20. A light emitting diode (LED) module comprising:
one or more LEDs to emit light; and
an identification resistor, the identification resistor comprising a particular resistance that can be used to determine an identification indication related to the LED module when current is applied across the identification resistor.
